(19) United States
(12) Patent Application Publication
(10) Pub. No.: US 2025/0365327 A1
(43) Pub. Date: Nov. 27, 2025

(54) TRANSFERRING AN IMS DATA CHANNEL SESSION BETWEEN USER EQUIPMENTS IN A COMMUNICATION NETWORK SYSTEM

(71) Applicant: Samsung Electronics Co., Ltd., Suwon-si (KR)

(72) Inventors: Anupam MAJUMDER, Bangalore (IN); Priti SINGH, Bangalore (IN); Sunil Kumar NAGARAJU, Bangalore (IN); Madhusudan Gorur MANJUNATH, Bangalore (IN)

(21) Appl. No.: 19/210,721

(22) Filed: May 16, 2025

Related U.S. Application Data
(63) Continuation of application No. PCT/KR2025/006355, filed on May 12, 2025.

(30) Foreign Application Priority Data
May 24, 2024 (IN) 202441040564
Apr. 3, 2025 (IN) 2024 41040564

(51) Int. Cl. H04L 65/1094; H04L 65/1016; H04L 65/1104; H04W 8/22

(52) U.S. Cl. CPC H04L 65/1094; H04L 65/1016; H04L 65/1104; H04W 8/22

(57) ABSTRACT

A method performed by a first user equipment (UE) for transferring an internet protocol (IP) multimedia subsystem (IMS) data channel (IDC) session between UEs in a communication network system is provided. The method includes determining, by the first UE, that an IDC session has been established between the first UE and the second UE, wherein the first UE and the second UE is in an ongoing IDC call, detecting, by the first UE, that an IDC call is being initiated by a third UE, initiating, by the first UE, the transfer of IDC session application state data from the first UE to the third UE, while maintaining the ongoing IDC call between the first UE and the second UE, and transmitting, by the first UE, the IDC session application state data to the second UE such that the second UE continues from same IDC session state where the first UE left-off with the third UE based on the IDC session application state data after the transfer is completed.

### CROSS-REFERENCE TO RELATED APPLICATION(S)

This application is a continuation application, claiming priority under 35 U.S.C. § 365(c), of an International application No. PCT/KR2025/006355, filed on May 12, 2025, which is based on and claims the benefit of an Indian Provisional patent application number 202441040564, filed on May 24, 2024, in the Indian Intellectual Property Office, and of an Indian Complete patent application number 202441040564, filed on Apr. 3, 2025, in the Indian Intellectual Property Office, the disclosure of each of which is incorporated by reference herein in its entirety.

### FIELD OF INVENTION

The disclosure relates to a communication networks. More particularly, the disclosure relates to transferring an internet protocol (IP) multimedia subsystem (IMS) data channel (IDC) session between user equipment's (UEs) in a communication network system.

### BACKGROUND

In wireless communication, advancements in fifth generation (5G) have enabled the introduction of the IDC in 3rd generation partnership project (3GPP) Release 16, enhancing capability for interactive features such as gaming, business collaboration, and content sharing during a voice over 5G (Vo5G) and voice over new radio (VoNR) calls. However, current IMS infrastructure does not support transferring the IDC session during call transfers. In the existing system, only audio and video media are transferred, while the IDC session is dropped, resulting in a partial call transfer and disrupting interactive services.

The problem is further complicated by the fact that the IMS call transfer flows do not support transferring sessions in a stateful manner. Media such as audio, video, and text do not require session states to be transferred, making them easier to move. However, the IDC involves maintaining specific session states, which is essential for the continuity of data services. As a result, transferring the IDC session along with the call requires changes to a current infrastructure.

In attended transfers, where a call is transferred to a user who is online, the IDC session cannot be transferred along with the audio or video call, leading to an interruption in interactive data services. Similarly, in unattended transfers, where the call is transferred to the user who is offline or unavailable, the IDC session is again dropped, further disrupting the continuity of the services.

These limitations create a significant gap in the functionality and user experience, as the users expect a seamless transition between devices and interactions, particularly in multi-user or shared experiences.

To address the aforementioned drawbacks, there is a need of technical solution that enables the transfer of the IDC session along with the audio and video components, whether the call is attended or unattended. This would ensure uninterrupted, interactive communication services during call transfers, greatly enhancing the user experience.

The above information is presented as background information only to assist with an understanding of the disclosure. No determination has been made, and no assertion is made, as to whether any of the above might be applicable as prior art with regard to the disclosure.

### OBJECT OF INVENTION

Aspects of the disclosure are to address at least the above-mentioned problems and/or disadvantages and to provide at least the advantages described below. Accordingly, an aspect of the disclosure is to provide transferring the IMS data channel session between the UEs in the communication network system.

Another aspect of the disclosure is to provide a seamless transfer of the IMS data channel application state to another user using a Call-Info Header and a MetaData XML.

Another aspect of the disclosure is to provide a Feature Tag in REGISTER and OPTIONS in order to identify the type of Transfer capabilities the other party.

Another aspect of the disclosure is to enable the unattended transfer with the ability to retain the IDC application state. When the other party becomes available, they may resume the call with the saved application state, ensuring continuity of the interactive services without any loss of data or context.

Additional aspects will be set forth in part in the description which follows and, in part, will be apparent from the description, or may be learned by practice of the presented embodiments.

### SUMMARY

In accordance with an aspect of the disclosure, a method performed by a first user equipment (UE) for transferring an internet protocol (IP) multimedia subsystem (IMS) data channel (IDC) session between UEs in a communication network system is provided. The method includes determining, by the first UE, that the IDC session has been established between the first UE and a second UE, wherein the first UE and the second UE is in an ongoing IDC call, detecting by the first UE that an IDC call is being initiated by a third UE, initiating by the first UE, a transfer of IDC session application state data from the first UE to the third UE, while maintaining the ongoing IDC call between the first UE and the second UE, and transmitting by the first UE the IDC session application state data to the second UE such that the second UE continues from same IDC session state where the first UE left-off with the third UE based on the IDC session application state data after the transfer is completed.

In accordance with another aspect of the disclosure, a first user equipment (UE) for transferring an internet protocol (IP) multimedia subsystem (IMS) data channel (IDC) session between user equipments (UEs) is provided. The first UE includes memory storing instructions, and at least one processor, wherein the instructions, when executed by the processor individually or collectively, cause the first UE to determine that an IDC session has been established between the first UE and the second UE, wherein the first UE and the second UE is in the ongoing IDC call, detect that the IDC call is being initiated by the third UE, initiate the transfer of IDC session application state data from the first UE to the third UE, while maintaining the ongoing IDC call between the first UE and the second UE, and transmit the IDC session application state data to the second UE such that the second UE continues from same IDC session state where the first UE left-off with the third UE based on the IDC session application state data after the transfer is completed.

In accordance with another aspect of the disclosure, one or more non-transitory computer-readable storage media storing one or more computer programs including computer-executable instructions that, when executed by one or more processors of a first user equipment (UE) individually or collectively, cause the first UE to perform operations. The operations include determining, by the first UE, that an data channel (IDC) session has been established between the first UE and a second UE, wherein the first UE and the second UE is in an ongoing IDC call, detecting, by the first UE, that an IDC call is being initiated by a third UE, initiating, by the first UE, a transfer of IDC session application state data from the first UE to the third UE, while maintaining the ongoing IDC call between the first UE and the second UE, and transmitting, by the first UE, the IDC session application state data to the second UE such that the second UE continues from same IDC session state where the first UE left-off with the third UE based on the IDC session application state data after the transfer is completed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a schematic representation that illustrates an IMS Data Channel Communication System in 5G Networks according to an embodiment of the disclosure;

FIG. 2 is a block diagram that illustrates limitations in an IMS Data Channel (IDC) session transfer, according to an embodiment of the disclosure;

FIGS. 3A, 3B, and 3C are block diagrams that illustrates a communication network system for transferring IDC session between UEs, according to various embodiments of the disclosure;

FIGS. 4A, 4B, and 4C are flowcharts that illustrates a communication network system for transferring an IDC session between UEs, according to various embodiments of the disclosure;

FIG. 5 is a sequence diagram that illustrates an IMS data channel application state transfer, according to an embodiment of the disclosure;

FIG. 6A is a flowchart that illustrates a method for enabling an IDC session continuity during a call transfer in an IMS network, specifically in the scenario where a third UE is unavailable to receive the call, according to an embodiment of the disclosure;

FIG. 6B is a flowchart that illustrates a method for enabling an IDC session continuity during a call transfer in an IMS network, specifically in a scenario where a third UE is available to receive a call, according to according to an embodiment of the disclosure;

FIG. 7 is a sequence diagram that illustrates an IDC Application State Transfer using HTTP Server with an RCS FT method, according to according to an embodiment of the disclosure;

FIG. 8 is the sequence diagram that illustrates an IDC Application State Transfer using the IDC method, according to according to an embodiment of the disclosure;

FIG. 9 is a sequence diagram that illustrates an IDC Application State Transfer using a MSRP method, according to according to an embodiment of the disclosure;

FIG. 10 is a sequence diagram that illustrates an IDC App State Transfer using the MSRP Method without the server, according to according to an embodiment of the disclosure;

FIG. 11 is a sequence diagram that illustrates the IDC App State Transfer Using the IDC method without the server, according to according to an embodiment of the disclosure;

FIG. 12 is a sequence diagram that illustrates an IDC App State Transfer using the offline IDC method with a server (SMS method) according to according to an embodiment of the disclosure;

FIG. 13A is a sequence diagram that illustrates flow for a third UE initiating IDC State with a second UE using a received IDC state, according to according to an embodiment of the disclosure;

FIG. 13B is a schematic representation of that illustrates a scenario where a third UE initiates an IDC call with a second UE based on a retrieved IDC session state, according to e according to an embodiment of the disclosure;

FIG. 14 is a block diagram that illustrates a process of capability exchange and an IDC application state ID generation, according to according to an embodiment of the disclosure;

FIGS. 15A, 15B, 15C, 15D, and 15E is a schematic representation that illustrates an example of a use case to transfer the data channel call session seamlessly, according to various embodiments of the disclosure;

FIG. 16 is a block diagram that illustrates an example of a use case for seamless transfer of a Data Channel call session between users, according to according to an embodiment of the disclosure; and

FIG. 17 is a sequence diagram that illustrates a scenario where a Data Channel Application state is transferred using an RCS file transfer when a third UE is RCS-capable, according to according to an embodiment of the disclosure.

Throughout the drawings, it should be noted that like reference numbers are used to depict the same or similar elements, features, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings facilitate understanding of various technical features. The embodiments are not limited by these drawings and extend to any alterations, equivalents, and substitutes. Terms like first, second, etc., are used for distinction and do not limit the elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

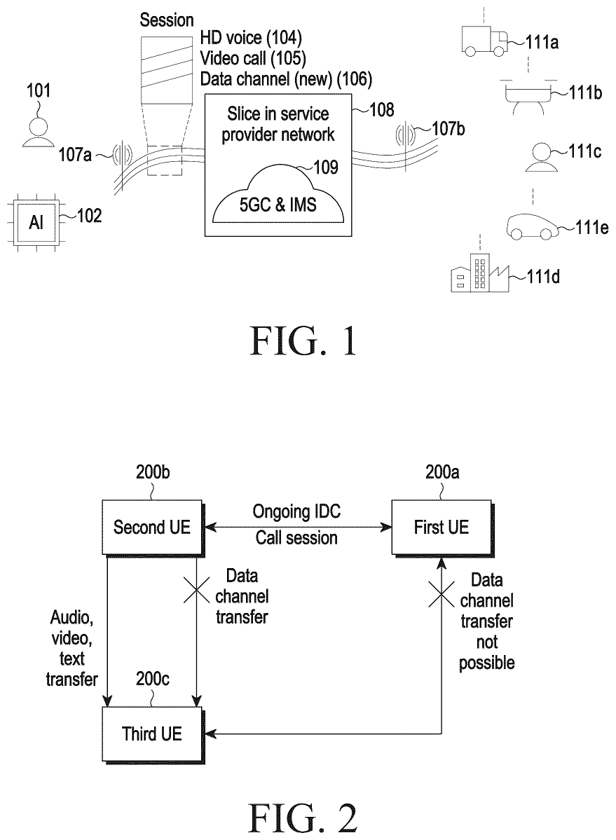

FIG. 1 is the schematic representation that illustrates an IMS Data Channel Communication System in the 5G Networks according to an embodiment of the disclosure.

Referring to FIG. 1, a session where HD voice (104), video call (105), and data channel (106) are transmitted with dedicated quality of service (QOS) through LTE/5G towers (107a and 107b), managed via a slice in the service provider network (108) consisting of the 5G core (5GC) and IMS is illustrated. Various user entities (109), including human users (101), AI-powered bots (102), autonomous vehicles (111a-111e), industrial systems, and Internet of Things (IoT) devices, may leverage the IDC for real-time data exchange, making Vo5G calls more interactive with services like gaming, interactive business meetings, and content sharing.

However, in the current implementation, while audio and video sessions may be transferred between users, the IDC session transfer is not possible, leading to session discontinuity and loss of interactive features. This limitation affects the seamless handover of advanced the 5G services.

FIG. 2 discloses the limitations in an IDC session transfer, where only audio, video, and text sessions may be transferred, while an IDC session remains untransferred according to an embodiment of the disclosure.

Referring to FIG. 2, an ongoing IDC call between the first UE (200a) and second UE (200b) is illustrated. When attempting to transfer the session to third UE (200c), only audio and video are transferred, while the IDC fails to transfer. As a result, interactive features such as real-time content sharing and gaming are lost, leading to a partial call transfer. This limitation highlights the need for the enhanced mechanism to enable the seamless IDC session transfer along with voice and video calls.

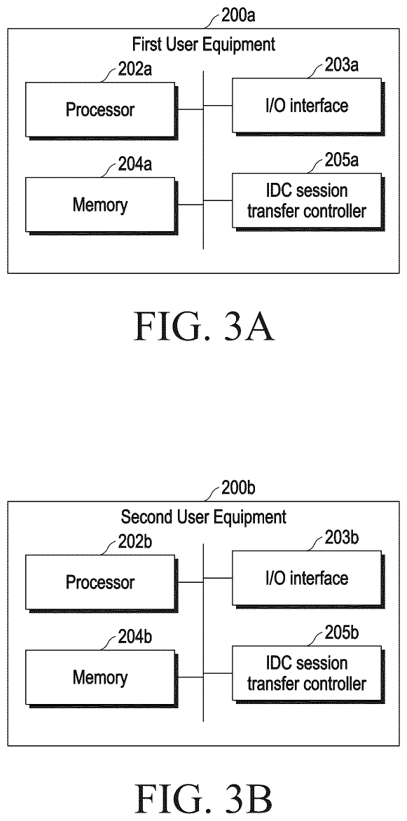

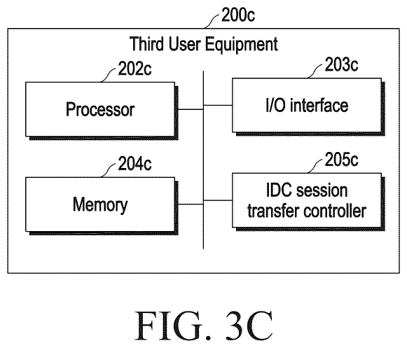

FIG. 3A is a block diagram that illustrates the communication network system for transferring the IDC session by first UE (200a) according to an embodiment of the disclosure.

Referring to FIG. 3A, examples of the UE may include, but are not limited to, consumer electronics (such as mobile phones and smartphones), tablets, wearable devices, television, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.).

Examples of the wireless communication network system include, but are not limited to, cellular networks (such as second generation (2G), third generation (3G), fourth generation (4G), 5G, beyond 5G (B5G)/sixth generation (6G), or advanced cellular networks), local area networks (LANs) (such as Wi-Fi, Li-Fi, etc.), personal area networks (PANs) (such as Bluetooth, Zigbee, Z-Wave, etc.), wide area networks (WANs) (such as satellite communication networks, long range wide area network, narrowband IoT, low-bandwidth communication for IoT, etc.), metropolitan area networks (MANs), machine-to-machine (M2M), Ad Hoc and mesh networks, emerging and advanced networks. Examples of the UE may include, but are not limited to, consumer electronics (such as mobile phones and smartphones), tablets, wearable devices, computing devices (such as laptops, notebooks, desktops, workstations, etc.), IoT devices, automotive systems (such as connected cars, autonomous vehicles, vehicle-to-everything (V2X) communication devices, etc.), enterprise devices such as robotics, specialized equipment (such as medical devices, public safety devices, etc.), media devices (such as gaming consoles, streaming devices, etc.).

In an embodiment, the UE (200) may include the first UE (200a). Further, the first UE may include the processor (202a), the memory (204a), an I/O interface (203a) and the IDC session transfer controller (205a). The processor (202a) may include the IDC session transfer controller (205a). For example, the first UE (200a) may include, but not limited to the first UE (300) may be at least one of smartphones, tablets, laptops, wearables, internet of things (IoT) devices, smart home devices, television, connected car and USB modems and the like. Further, the processor (202a) of the first UE (200a) communicates with the memory (204a), the I/O interface (203a) and the IDC session transfer controller (205a). The processor (202a) execute instructions stored in the memory (204a) and to perform various processes. The processor (202a) may include one or a plurality of processors, may be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU). Furthermore, the processor (202a) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory (204a) of the first UE (200a) may include specific message configurations and device-specific information related to the IDC session transfer process. The memory may further include comprehensive device-specific information for the first UE (200a), encompassing unique device identifiers, communication protocol configurations, and system parameters. The memory (204a) is not limited to volatile memory and/or non-volatile memory. Further, the memory (204a) may include one or more computer-readable storage media. The memory (204a) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories.

The I/O interface (203a) is configured for communicating internally between internal hardware components and with external devices (client device) via one or more networks. The I/O interface (203a) may include an electronic circuit that enables wired or wireless communication.

The IDC session transfer controller (205a) is coupled to the memory (204a) and the processor (202a). This coupling allows for efficient data transfer and communication between the components, ensuring that the IDC session transfer controller (205a) may access and process IDC session data in real-time. The IDC session transfer controller (205a) is an innovative integrated circuit that is implemented in the first UE (200a). In an embodiment, the structure of such innovative integrated circuit may include a multi-core architecture that enables dynamic management of IDC session transfer in a communication system. Each core is optimized for specific tasks, such as signal processing, session state management, and adjusting IDC session transfer configuration, etc. The innovative integrated circuit for dynamic IDC session transfer in the communication system is made of a combination of analog and digital components designed to optimize the power consumption and performance of the session transfer mechanism. The analog components include a low-noise amplifier and a high-precision analog-to-digital converter to ensure accurate signal processing. The digital components consist of a microcontroller unit (MCU) and a digital signal processor (DSP) that work in tandem to dynamically manage the IDC session transfer based on IDC session configuration.

The IDC session transfer controller (205a) in the first UE (200a) determines that the IDC has been established between the first UE and the second UE. The first UE and the second UE (200b) is in the ongoing IDC call. The IDC session transfer controller (205a) in the first UE (200a) detects that the IDC call is being initiated by the third UE (200c). The IDC session transfer controller (205a) in the first UE (200a) initiates the transfer of IDC session application state data from the first UE (200a) to the third UE (200c), while maintaining the ongoing IDC call between the first UE (200a) and the second UE (200b). The IDC session transfer controller (205a) in the first UE (200a) sends the IDC session application state data to the second UE (200b) such that the second UE (200b) may continue from same IDC session state where the first UE (200a) left-off with the third UE (200c) based on the IDC session application state data after the transfer is completed.

The IDC session transfer controller (205a) in the first UE (200a) transfers the IDC session state from the first UE to the third UE (200c). The IDC session transfer controller (205a) in the first UE (200a) sends the SUBSCRIBE or OPTIONS request message to the third UE (200c) to retrieve the capability of the third UE (200c). The IDC session transfer controller (205a) in the first UE (200a) receives the SUBSCRIBE or OPTIONS response message from the third UE (200c). The IDC session transfer controller (205a) in the first UE (200a) determines the capability of the third UE (200c) based on the feature tag available in the SUBSCRIBE or OPTIONS response received from the third UE (200c). The feature tag indicates one of the data transfers using HTTP file transfer (dc-transfer-httpft), the direct connection file transfer (dc-transfer-dcft), the Message Session Relay Protocol file transfer (dc-transfer-msrpft), the dc-transfer-msrp, the dc-transfer-nomedia, when the third UE (200c) is online. The third UE (200c) has dc-transfer-offline when the third UE (200c) is offline. The IDC session transfer controller (205a) in the first UE (200a) transfers the IDC session application state data from the first UE (200a) to the third UE (200c) using the rich communication services file transfer (RCS-FT) based method with storage, when the capability indicates that the third UE (200c) has support for the dc-transfer-httpft. The IDC session transfer controller (205a) in the first UE (200a) transfers the IDC session application state data from the first UE (200a) to the third UE (200c) using IDC based method with storage, when the capability indicates that the third UE (200c) has support for the dc-transfer-dcft. The IDC session transfer controller (205a) in the first UE (200a) transfers the IDC session application state data from the first UE (200a) to the third UE (200c) using MSRP based method with storage, when the capability indicates that the third UE has support for the dc-transfer-msrpft. The IDC session transfer controller (205a) in the first UE (200a) transfers the IDC session application state data from the first UE (200a) to the third UE (200c) using MSRP based method without storage, when the capability indicates that the third UE has support for the dc-transfer-msrp. The IDC session transfer controller (205a) in the first UE (200a) transfers the IDC session application state data from the first UE (200a) to the third UE (200c) using IDC based method without storage, when the capability indicates that the third UE has support for the dc-transfer-nomedia. The IDC session transfer controller (205a) in the first UE (200a) transfers the IDC session application state data from the first UE (200a) to the third UE (200c) in offline mode, when the capability indicates that the third UE (200c) has support for the dc-transfer-offline.

The IDC session transfer controller (205a) in the first UE (200a) transfers the IDC session application state data from the first UE (200a) to the third UE (200c) using the RCS-FT based method with storage. The IDC session transfer controller (205a) in the first UE (200a) upload the IDC session application state data to an operator HTTP storage server before initiating the transfer of the IDC call. The IDC session transfer controller (205a) in the first UE (200a) establishes the file transfer over HTTP (FToverHTTP) session with the third UE (200c). The third UE (200c) is the RCS enabled client supporting file transfer using HTTP. The IDC session transfer controller (205a) in the first UE (200a) establishes the FToverHTTP session with the third UE (200c). The IDC session transfer controller (205a) in the first UE (200a) adds metadata and +sipapp-subtype media feature tag in the SIP INVITE multipart message. The metadata may include at least one of the previous application state Identifier (ID), the file URL, the file correlation ID, and participant information. The IDC session transfer controller (205a) in the first UE (200a) sends the SIP INVITE multipart message to the third UE (200c). The IDC session transfer controller (205a) in the first UE (200a) sends the SIP REFER message to the IMS network (201) server to initiate the call transfer. The SIP REFER message may include the Call-Info header.

The IDC session transfer controller (205a) in the first UE (200a) transfers the IDC session application state data from the first UE (200a) to the third UE (200c) using the IDC based method with storage. The IDC session transfer controller (205a) in the first UE (200a) uploads the IDC session application state data to the operator HTTP storage server before initiating the transfer of the IDS call. The first UE or the third UE are not RCS enabled clients. The IDC session transfer controller (205a) in the first UE (200a) establishing the IDC session with the third UE. The IDC session transfer controller (205a) in the first UE (200a) add the Call-Info header and +sip.app-subtype media feature tag to the SIP INVITE multipart message. The Call-Info header may include the previous application state ID, file URL, the file correlation ID, and participant information. The IDC session transfer controller (205a) in the first UE (200a) sends the SIP INVITE multipart message to the third UE (200c). The IDC session transfer controller (205a) in the first UE (200a) sends the SIP REFER request message to the IMS network (201) server to transfer the IDC call. The SIP REFER request message may include the Call-Info header.

The IDC session transfer controller (205a) in the first UE (200a) transfers the IDC session application state data from the first UE (200a) to the third UE (200c) using the MSRP based method with storage. The IDC session transfer controller (205a) in the first UE (200a) uploads the IDC session application state data to the operator HTTP storage server before initiating the transfer of the IDC call. The first UE (200a) and the second UE (200b) are RCS enabled clients supporting MSRP for data transfer. The IDC session transfer controller (205a) in the first UE (200a) establishes the MSRP session with the third UE (200c). The IDC session transfer controller (205a) in the first UE (200a) sends the SIP INVITE multipart message by adding the +sip.app-subtype media feature tag to the third UE (200c). The SIP INVITE multipart message including metadata having at least one of previous application state ID, the file URL, the file correlation ID, and participant information. The IDC session transfer controller (205a) in the first UE (200a) sends the SIP REFER message to the IMS network (201) server to transfer the IDC call. The SIP REFER message may include the Call-Info header.

The IDC session transfer controller (205a) in the first UE (200a) transfers the IDC session application state data from the first UE (200a) to the third UE (200b) using the MSRP based method without storage. The IDC session transfer controller (205a) in the first UE (200a) establishes the MSRP session between the first UE (200a) and third UE (200c). The first UE (200a) and the second UE (200b) are RCS enabled clients that support MSRP for the transfer of the IDC call. The IDC session transfer controller (205a) in the first UE (200a) adds the Call-Info header and the +sipapp-subtype media feature tag to the SIP INVITE request message. The Call-Info header may include previous application state ID, the file URL, the file correlation ID, and participant information. The IDC session transfer controller (205a) in the first UE (200a) sends the SIP INVITE request message from the first UE (200a) to the third UE (200c). The IDC session transfer controller (205a) in the first UE (200a) sends the SIP REFER request message to the IMS network (201) server to transfer the IDC call. The SIP REFER request message may include the Call-Info header.

The IDC session transfer controller (205a) in the first UE (200a) transfers the IDC session application state data from the first UE (200a) to the third UE (200c) using IDC based method without storage. The IDC session transfer controller (205a) in the first UE (200a) establishes the IDC session with the third UE with the dedicated stream for sending and receiving the IDC session application state data. The first UE (200a) and the second UE (200b) is not the RCS enabled client. The IDC session transfer controller (205a) in the first UE (200a) adds the call-Info header and +sipapp-subtype media feature tag to the SIP INVITE request. The Call-Info header may include at least one of the previous application state ID, the file URL, the file correlation ID, and participant information. The IDC session transfer controller (205a) in the first UE (200a) sends the SIP INVITE request message to third UE (200c). The IDC session transfer controller (205a) in the first UE (200a) sends the SIP REFER request message to the IMS network (201) server to transfer the IDC call. The SIP REFER request message may include the Call-Info header.

The IDC session transfer controller (205a) in the first UE (200a) transfers the IDC session application state data from the first UE (200a) to the third UE (200c) in the offline mode. The IDC session transfer controller (205a) in the first UE (200a) uploads the IDC session application state data to the HTTP server. The third UE (200c) is not RCS capable and is unavailable to receive the IDC state or cannot receive the transfer of the IDC call. The IDC session transfer controller (205a) in the first UE (200a) sends the SIP message to the second UE (200b) or the IMS network (201) server. The SIP message may include file details related to the IDC session application state data. The IDC session transfer controller (205a) in the first UE (200a) adds the Call-Info header and +sip.app-subtype media feature tag to the SIP INVITE request, the Call-Info header may include the previous application state ID, the file URL, the file correlation ID, and participant information. The IDC session transfer controller (205a) in the first UE (200a) sends the SIP REFER request to the IMS network (201) server to transfer the IDC call. The IMS network (201) server responds with the client error indicating that the third UE (200c) is not reachable.

The IDC session transfer controller (205a) determines the IDC has been established between the first UE (200a) and the second UE (200b). The first UE (200a) and the second UE (200b) is in the ongoing IDC call. The IDC session transfer controller (205a) detects that the IDC call is being initiated by the third UE (200c). The IDC session transfer controller (205a) initiates the transfer of IDC session application state data from the first UE (200a) to the third UE (200c), while maintaining the ongoing IDC call between the first UE (200a) and the second UE (200b). The IDC session transfer controller (205a) sends the IDC session application state data to the second UE (200b) such that the second UE (200b) may continue from same IDC session state where the first UE (200a) left-off with the third UE (200c) based on the IDC session application state data after the transfer is completed.

The IDC session transfer controller (205a) transfers the IDC session state from the first UE to the third UE (200c). The IDC session transfer controller (205a) sends the SUBSCRIBE or OPTIONS request message to the third UE (200c) to retrieve the capability of the third UE (200c). The IDC session transfer controller (205a) receives the SUBSCRIBE or OPTIONS response message from the third UE (200c). The IDC session transfer controller (205a) determines the capability of the third UE (200c) based on the feature tag available in the SUBSCRIBE or OPTIONS response received from the third UE (200c). The feature tag indicates one of the data transfers using HTTP file transfer (dc-transfer-httpft), the direct connection file transfer (dc-transfer-dcft), the Message Session Relay Protocol file transfer (dc-transfer-msrpft), the dc-transfer-msrp, the dc-transfer-nomedia, when the third UE (200c) is online. The third UE (200c) has dc-transfer-offline when the third UE (200c) is offline. The IDC session transfer controller (205a) transfers the IDC session application state data from the first UE (200a) to the third UE (200c) using the Rich Communication Services File Transfer (RCS-FT) based method with storage, when the capability indicates that the third UE (200c) has support for the dc-transfer-httpft. The IDC session transfer controller (205a) transfers the IDC session application state data from the first UE (200a) to the third UE (200c) using IDC based method with storage, when the capability indicates that the third UE (200c) has support for the dc-transfer-dcft. The IDC session transfer controller (205a) transfers the IDC session application state data from the first UE (200a) to the third UE (200c) using MSRP based method with storage, when the capability indicates that the third UE has support for the dc-transfer-msrpft. The IDC session transfer controller (205a) transfers the IDC session application state data from the first UE (200a) to the third UE (200c) using MSRP based method without storage, when the capability indicates that the third UE has support for the dc-transfer-msrp. The IDC session transfer controller (205a) transfers the IDC session application state data from the first UE (200a) to the third UE (200c) using IDC based method without storage, when the capability indicates that the third UE has support for the dc-transfer-nomedia. The IDC session transfer controller (205a) transfers the IDC session application state data from the first UE (200a) to the third UE (200c) in offline mode, when the capability indicates that the third UE (200c) has support for the dc-transfer-offline.

The IDC session transfer controller (205a) transfers the IDC session application state data from the first UE (200a) to the third UE (200c) using the RCS-FT based method with storage. The IDC session transfer controller (205a) upload the IDC session application state data to an operator HTTP storage server before initiating the transfer of the IDC call. The IDC session transfer controller (205a establishes the FToverHTTP session with the third UE (200c). The third UE (200c) is the RCS enabled client supporting File Transfer using HTTP. The IDC session transfer controller (205a) establishes the FToverHTTP session with the third UE (200c). The IDC session transfer controller (205a) adds metadata and +sipapp-subtype media feature tag in the SIP INVITE multipart message. The metadata may include at least one of the previous application state Identifier (ID), the file URL, the file correlation ID, and participant information. The IDC session transfer controller (205a) in the first UE (200a) sends the SIP INVITE multipart message to the third UE (200c). The IDC session transfer controller (205a) in the first UE (200a) sends the SIP REFER message to the IMS network (201) server to initiate the call transfer. The SIP REFER message may include the Call-Info header.

The IDC session transfer controller (205a) transfers the IDC session application state data from the first UE (200a) to the third UE (200c) using the RCS-FT based method with storage. The IDC session transfer controller (205a) upload the IDC session application state data to the operator HTTP storage server before initiating the transfer of the IDC call. The IDC session transfer controller (205a) establishes the FToverHTTP session with the third UE (200c). The third UE (200c) is the RCS enabled client supporting File Transfer using HTTP. The IDC session transfer controller (205a) in the first UE (200a) establishes the FToverHTTP session with the third UE (200c). The IDC session transfer controller (205a) adds metadata and +sipapp-subtype media feature tag in the SIP INVITE multipart message. The metadata may include at least one of the previous application state ID, the file URL, the file correlation ID, and participant information. The IDC session transfer controller (205a) in the first UE (200a) sends the SIP INVITE multipart message to the third UE (200c). The IDC session transfer controller (205a) sends the SIP REFER message to the IMS network (201) server to initiate the call transfer. The SIP REFER message may include the Call-Info header.

The IDC session transfer controller (205a) transfers the IDC session application state data from the first UE (200a) to the third UE (200c) using the IDC based method with storage. The IDC session transfer controller (205a) uploads the IDC session application state data to the operator HTTP storage server before initiating the transfer of the IDS call. The first UE (200a) or the third UE (200c) are not RCS enabled clients. The IDC session transfer controller (205a) in the first UE (200a) establishing the IDC session with the third UE. The IDC session transfer controller (205a) adds the Call-Info header and +sip.app-subtype media feature tag to the SIP INVITE multipart message. The Call-Info header may include the previous application state ID, file URL, the file correlation ID, and participant information. The IDC session transfer controller (205a) sends the SIP INVITE multipart message to the third UE (200c). The IDC session transfer controller (205a) sends the SIP REFER request message to the IMS network (201) server to transfer the IDC call. The SIP REFER request message may include the Call-Info header.

The IDC session transfer controller (205a) transfers the IDC session application state data from the first UE (200a) to the third UE (200c) using the MSRP based method with storage. The IDC session transfer controller (205a) uploads the IDC session application state data to the operator HTTP storage server before initiating the transfer of the IDC call. The first UE (200a) and the second UE (200b) are RCS enabled clients supporting MSRP for data transfer. The IDC session transfer controller (205a) establishes the MSRP session with the third UE (200c). The IDC session transfer controller (205a) sends the SIP INVITE multipart message by adding the +sip.app-subtype media feature tag to the third UE (200c). The SIP INVITE multipart message including metadata having the previous application state ID, the file URL, the file correlation ID, and participant information. The IDC session transfer controller (205a) sends the SIP REFER message to the IMS network (201) server to transfer the IDC call. The SIP REFER message may include the Call-Info header.

The IDC session transfer controller (205a) transfers the IDC session application state data from the first UE (200a) to the third UE (200b) using the MSRP based method without storage. The IDC session transfer controller (205a) establishes the MSRP session between the first UE (200a) and third UE (200c). The first UE (200a) and the second UE (200b) are RCS enabled clients that support MSRP for the transfer of the IDC call. The IDC session transfer controller (205a) adds the Call-Info header and the +sipapp-subtype media feature tag to the SIP INVITE request message. The Call-Info header may include previous application state ID, the file URL, the file correlation ID, and participant information. The IDC session transfer controller (205a) sends the SIP INVITE request message from the first UE (200a) to the third UE (200c). The IDC session transfer controller (205a) sends the SIP REFER request message to the IMS network (201) server to transfer the IDC call. The SIP REFER request message may include the Call-Info header.

The IDC session transfer controller (205a) transfers the IDC session application state data from the first UE (200a) to the third UE (200c) using IDC based method without storage. The IDC session transfer controller (205a establishes the IDC session with the third UE with the dedicated stream for sending and receiving the IDC session application state data. The first UE (200a) and the second UE (200b) is not the RCS enabled client. The IDC session transfer controller (205a) in the first UE (200a) adds the call-Info header and +sipapp-subtype media feature tag to the SIP INVITE request. The Call-Info header may include at least one of the previous application state ID, the file URL, the file correlation ID, and participant information. The IDC session transfer controller (205a) sends the SIP INVITE request message to third UE (200c). The IDC session transfer controller (205a) sends the SIP REFER request message to the IMS network (201) server to transfer the IDC call. The SIP REFER request message may include the Call-Info header.

The IDC session transfer controller (205a) transfers the IDC session application state data from the first UE (200a) to the third UE (200c) in the offline mode. The IDC session transfer controller (205a) uploads the IDC session application state data to the HTTP server. The third UE (200c) is not RCS capable and is unavailable to receive the IDC state or cannot receive the transfer of the IDC call. The IDC session transfer controller (205a) sends the SIP message to the second UE (200b) or the IMS network (201) server. The SIP message may include file details related to the IDC session application state data. The IDC session transfer controller (205a) adds the Call-Info header and +sip.app-subtype media feature tag to the SIP INVITE request, the Call-Info header may include the previous application state ID, the file URL, the file correlation ID, and participant information. The IDC session transfer controller (205a) sends the SIP REFER request to the IMS network (201) server to transfer the IDC call. The IMS network (201) server responds with the client error indicating that the third UE (200c) is not reachable.

FIG. 3B is the block diagram that illustrates a communication network system for transferring an IDC session by a second UE according to an embodiment of the disclosure.

Referring to FIG. 3B, the second UE (200b) may include the processor (202b), the memory (204b), an I/O interface (203b) and the IDC session transfer controller (205b). For example, the Second UE (200b) may include, but not limited to the second UE (200b) may be at least one of smartphones, tablets, laptops, wearables, IoT devices, smart home devices, television, connected car and USB modems and the like.

Further, the processor (202b) of the second UE (200b) communicates with the memory (204b), the I/O interface (203b) and the IDC session transfer controller (205b). The processor (202b) execute instructions stored in the memory (204b) and to perform various processes. The processor (202b) may include one or a plurality of processors, may be a general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as a neural processing unit (NPU).

The memory (204b) of the second UE (200b) may include specific message configurations and device-specific information related to the IDC session transfer process. The memory further may include comprehensive device-specific information for the second UE (200b), encompassing unique device identifiers, communication protocol configurations, and system parameters. The memory (204b) is not limited to volatile memory and/or non-volatile memory. Further, the memory (204b) may include one or more computer-readable storage media. The memory (204a) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories.

The I/O interface (203b) is configured for communicating internally between internal hardware components and with external devices (client device) via one or more networks. The I/O interface (203b) may include an electronic circuit that enables wired or wireless communication.

The IDC session transfer controller (205b) is coupled to the memory (204b) and the processor (202b). This coupling allows for efficient data transfer and communication between the components, ensuring that the IDC session transfer controller (205b) may access and process IDC session state data in real-time. The IDC session transfer controller (205b) is an innovative integrated circuit that is implemented in the Second UE (200b). In an embodiment, the structure of such innovative integrated circuit may include the multi-core architecture that enables dynamic management of IDC session state reception and transfer in the communication system. Each core is optimized for specific tasks, such as signal processing, session state data management, and adjusting IDC session state transfer configuration, etc. The innovative integrated circuit for dynamic IDC session transfer in the communication system is made of the combination of analog and digital components designed to optimize the power consumption and performance of the session transfer mechanism. The analog components include the low-noise amplifier and the high-precision analog-to-digital converter to ensure accurate signal processing. The digital components consist of the microcontroller unit (MCU) and the digital signal processor (DSP) that work in tandem to dynamically manage the IDC session state data transfer based on IDC session configuration.

Further, the IDC session transfer controller (205b) in the second UE (200b) receives the IDC session application state data from the first UE (200a). Further, the IDC session transfer controller (205b) in the second UE (200b) stores the IDC session application state data such that the second UE (200b) and third UE (200c) may continue communication from the same IDC session state of the first UE (200a) based on the IDC session application state data.

Further, the IDC session transfer controller (205b) in the second UE (200b) receives the IDC session application state data from the first UE (200a). Further, the IDC session transfer controller (205b) in the second UE (200b) stores the IDC session application state data such that the second UE (200b) and the third UE (200c) may continue communication from the same IDC session state of the first UE based on the IDC session application state data.

Further, the IDC session transfer controller (205b) receives the IDC session application state data from the first UE (200a). Further, the IDC session transfer controller (205b) stores the IDC session application state data such that the second UE (200b) and the third UE (200c) may continue communication from the same IDC session state of the first UE based on the IDC session application state data.

FIG. 3C is the block diagram that illustrates a communication network system for transferring an IDC session by a second UE according to an embodiment of the disclosure.

Referring to FIG. 3C, the third UE (200c) may include the processor (202c), the memory (204c), an I/O interface (203c) and the IDC session transfer controller (205c). For example, the third UE (200c) includes, but not limited to the third UE (200c) may be at least one of smartphones, tablets, laptops, wearables, IoT devices, smart home devices, television, connected car and USB modems and the like.

Further, the processor (202c) of the third UE (200c) communicates with the memory (204c), the I/O interface (203c) and the IDC session transfer controller (205c). The processor (202c) executes instructions stored in the memory (204c) and to perform various processes. The processor (202c) may include one or the plurality of processors, may be the general-purpose processor, such as a central processing unit (CPU), an application processor (AP), or the like, a graphics-only processing unit such as a graphics processing unit (GPU), a visual processing unit (VPU), and/or an artificial intelligence (AI) dedicated processor such as the neural processing unit (NPU).

The memory (204c) of the third UE (200c) may include specific message configurations and device-specific information related to the IDC session transfer process. The memory may further include comprehensive device-specific information for the third UE (200c), encompassing unique device identifiers, communication protocol configurations, and system parameters. The memory (204c) is not limited to volatile memory and/or non-volatile memory. Further, the memory (204c) may include one or more computer-readable storage media. The memory (204c) may include non-volatile storage elements. For example, non-volatile storage elements may include magnetic hard discs, optical discs, floppy discs, flash memories, or forms of electrically programmable memories (EPROM) or electrically erasable and programmable (EEPROM) memories.

The I/O interface (203c) is configured for communicating internally between internal hardware components and with external devices (client device) via one or more networks. The I/O interface (203c) may include an electronic circuit that enables wired or wireless communication.

The IDC session transfer controller (205c) is coupled to the memory (204c) and the processor (202c). This coupling allows for efficient data transfer and communication between the components, ensuring that the IDC session transfer controller (205c) may access and process IDC session state data in real-time. The IDC session transfer controller (205c) is an innovative integrated circuit that is implemented in the Third UE (200c). In an embodiment, the structure of such innovative integrated circuit may include the multi-core architecture that enables dynamic management of IDC session state reception and transfer in the communication system. Each core is optimized for specific tasks, such as signal processing, session state data management, and adjusting IDC session state transfer configuration, etc. The innovative integrated circuit for dynamic IDC session transfer in the communication system is made of the combination of analog and digital components designed to optimize the power consumption and performance of the session transfer mechanism. The analog components include the low-noise amplifier and the high-precision analog-to-digital converter to ensure accurate signal processing. The digital components consist of the microcontroller unit (MCU) and a digital signal processor (DSP) that work in tandem to dynamically manage the IDC session state data transfer based on IDC session configuration. The third UEs (200c) IDC session transfer controller (205c) receives the SIP INVITE message from the first UE (200a), stores the IDS application state data to the local database, receives the call from the IMS network (201) server, fetching the application state from the local database and resuming the IDC session from the exact state where the first UE (200a) left off.

Further, the IDC session transfer controller (205c) in the third UE (200c) receives the SIP INVITE message from the first UE (200a). The SIP INVITE message may include the Call-Info header and +sip.app-subtype media feature tag. The IDC session transfer controller (205c) stores the IDS application state data to the local database based on the SIP INVITE message. the IDC session transfer controller (205c) in the third UE (200c) receives the call from the IMS network (201) server with the Call-Info header unchanged. the IDC session transfer controller (205c) in the third UE (200c) fetches the application state from the local database. the IDC session transfer controller (205c) receives resumes the IDC session from the same IDC session state where the first UE (200a) left-off.

Further, the IDC session transfer controller (205c) in the third UE (200c) receives the SIP INVITE multipart message from the operator HTTP storage server. The SIP INVITE multipart message may include the +sipapp-subtype media feature tag. IDC session state where the first UE (200a) left-off.

Further, the IDC session transfer controller (205c) in the third UE (200c) downloads the file including the IDC session application state data from the operator HTTP storage server based on the SIP INVITE request. IDC session state where the first UE (200a) left-off. The IDC session transfer controller (205c) in the third UE (200c) stores the IDC session application state data to the local database using the previous application state ID as the primary key. The IDC session transfer controller (205c) in the third UE (200c) receives the call from the IMS network (201) server with the Call-Info header unchanged. The IDC session transfer controller (205c) in the third UE (200c) fetches the application state from the local database. The IDC session transfer controller (205c) in the third UE (200c) resumes the IDC session from the same IDC session state where the first UE left-off.

Further, the IDC session transfer controller (205c) in the third UE (200c) receives the SIP INVITE multipart message from the first UE (200a). The SIP INVITE multipart message may include the Call-Info header and the +sip.app-subtype media feature tag. The IDC session transfer controller (205c) in the third UE (200c) downloads the file from the operator HTTP storage server upon receiving the SIP INVITE request. The IDC session transfer controller (205c) in the third UE (200c) stores the IDS application state data to the local database using the previous application state id as the primary key. The IDC session transfer controller (205c) in the third UE (200c) receives the call from the IMS network (201) server with the Call-Info header unchanged. The IDC session transfer controller (205c) in the third UE (200c) fetches the application state from the local database. The IDC session transfer controller (205c) in the third UE (200c) resumes the IDC session from the same IDC session state where the first UE left-off.

Further, the IDC session transfer controller (205c) in the third UE (200c) receives SIP INVITE request message from the first UE. The SIP INVITE request message may include the Call-Info header and the +sipapp-subtype media feature tag. The IDC session transfer controller (205c) in the third UE (200c) establishes the MSRP session with the first UE based on the SIP INVITE request. the IDC session transfer controller (205c) in the third UE (200c) receives the Call-Info header over the MSRP session. the IDC session transfer controller (205c) in the third UE (200c) stores the IDC session application state data to the local database using the previous application state ID as the primary key. the IDC session transfer controller (205c) in the third UE (200c) receives the call from the IMS network (201) server with the Call-Info header unchanged. the IDC session transfer controller (205c) in the third UE (200c) fetches the application state from the local database. The IDC session transfer controller (205c) in the third UE (200c) resumes the IDC session from the same IDC session state where the first UE (200a) left-off.

Further, the IDC session transfer controller (205c) in the third UE (200c) receives the SIP INVITE request message from the first UE. The SIP INVITE request message may include the Call-Info header and the +sipapp-subtype media feature tag. The IDC session transfer controller (205c) in the third UE (200c) periodically polls the dedicated stream for the IDC session application state data based on the SIP INVITE request message. The IDC session transfer controller (205c) in the third UE (200c) stores the IDC session application state data to the local database using the previous application state ID as the primary key. The IDC session transfer controller (205c) in the third UE (200c) receives the call from the IMS network (201) server with the Call-Info header unchanged. The IDC session transfer controller (205c) in the third UE (200c) fetches the application state from the local database. The IDC session transfer controller (205c) in the third UE (200c) resumes the IDC session from the same IDC session state where the first UE (200a) left-off.

Further, the IDC session transfer controller (205c) in the third UE (200c) downloads the IDC session application state data from the local database when the third UE (200c) becomes available or comes online. The IDC session transfer controller (205c) in the third UE (200c) initiates the IDC call automatically by clicking on the message including the URL to complete pending IDC session.

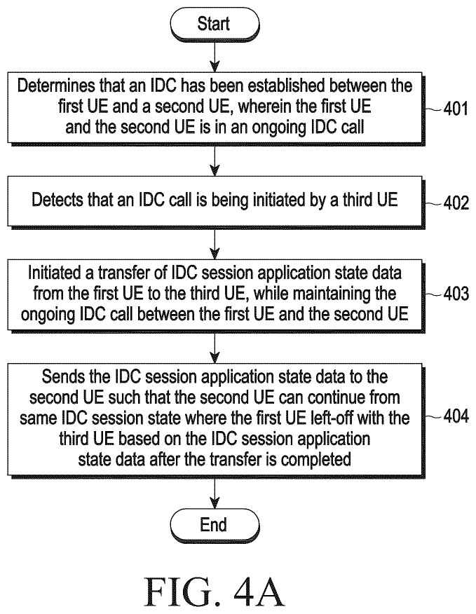

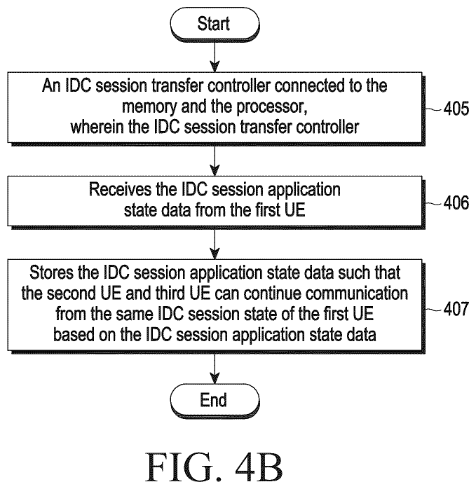

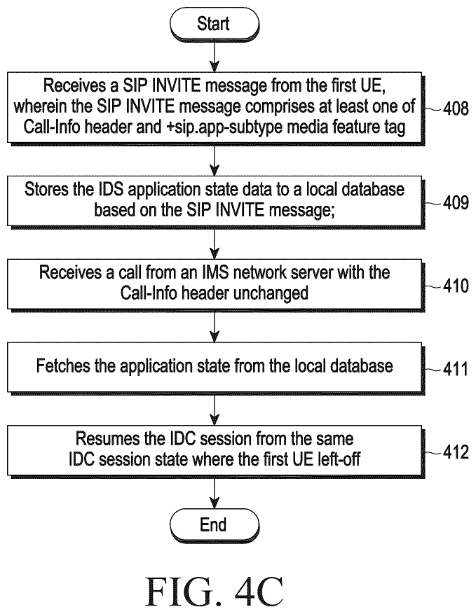

FIG. 4A is the flow chart that illustrates a method for transferring an IDC session by a first UE in the communication network system according to an embodiment of the disclosure.

Referring to FIG. 4A, at operation 401, determining that the IDC session has been established between the first UE (200a) and the second UE (200b), and that are engaged in the ongoing IDC call.

At operation 402, determining that the IDC call is being initiated by the third UE (200c), as detected by the first UE (200a).

At operation 403, initiating the transfer of IDC session application state data from the first UE (200a) to the third UE (200c), while maintaining the ongoing IDC call between the first UE (200a) and the second UE (200b).

At operation 404, sending the IDC session application state data to the second UE, allowing the second UE to continue the IDC session from the same state where the first UE (200a) left off with the third UE (200c) after the transfer is completed.

FIG. 4B is a flow chart that illustrates a method for transferring an IDC session by a second UE in a communication network system according to an embodiment of the disclosure.

Referring to FIG. 4B, at operation 405, storing the IDC session application state data by the second UE (200b), enabling the second UE (200b) and the third UE (200c) to continue communication from the same IDC session state of the first UE (200a), based on the received IDC session application state data.

At operation 406, storing the IDC session application state data, by the second UE, such that the second UE (200b) and the third UE (200c) may continue communication from the same IDC session state of the first UE (200a) based on the IDC session application state data.

FIG. 4C is a flow chart that illustrates a method for transferring an IDC session by a third UE in a communication network system according to an embodiment of the disclosure.

Referring to FIG. 4C, at operation 407, receiving the SIP INVITE multipart message from the operator HTTP storage server by the third UE (200c), where the SIP INVITE multipart message may include the +sipapp-subtype media feature tag.

At operation 408, downloading the file containing the IDC session application state data from the operator HTTP storage server by the third UE (200c) based on the SIP INVITE request.

At operation 409, storing the IDC session application state data in the local database by the third UE (200c), using the previous application state ID as the primary key.

At operation 410, receiving the call from the IMS network server by the third UE (200c) with the Call-Info header remaining unchanged.

At operation 411, fetching the application state from the local database by the third UE (200c).

At operation 412, resuming the IDC session from the same session state where the first UE (200a) left off by the third UE (200c).

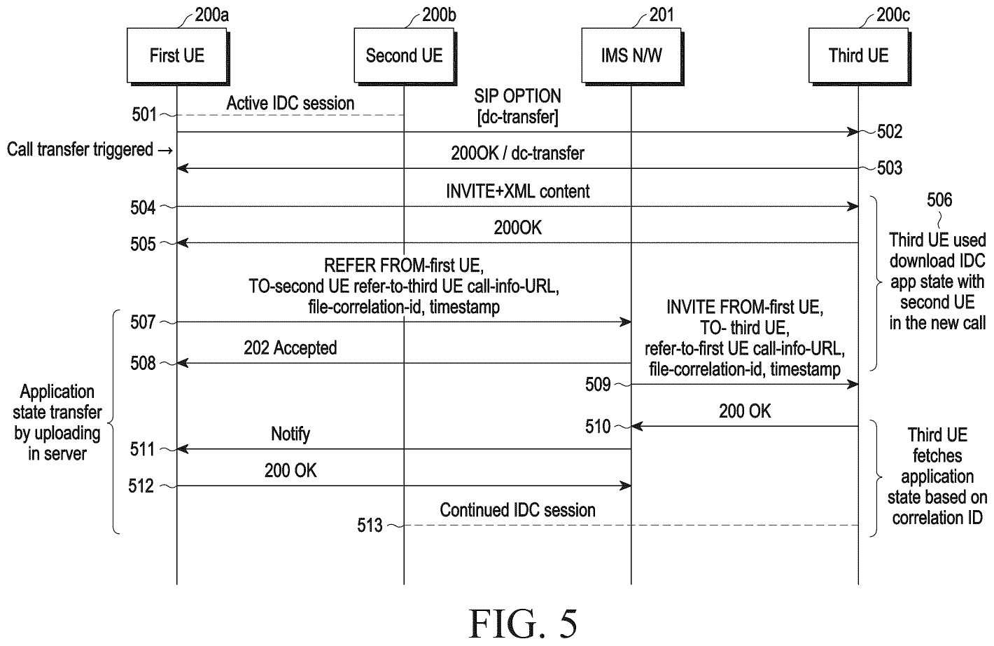

FIG. 5 illustrates the scenario where a second UE and a first UE are engaged in an IDC call, and the first UE intends to transfer an ongoing IDC session to a UE C according to an embodiment of the disclosure. In this process the second UE (200B) acts as the transferee (the recipient of the transferred session), the first UE (200a) is the transferor (initiating the transfer) and the third UE (200c) is the transfer target (the new recipient of the session).

Referring to FIG. 5, at operations 501, an active IDC session is established between the second UE (200b) and the first UE (200a) over the IMS network (201). This session facilitates the IDC communication between the UEs.

At operations 502 and 503, the first UE (200a) and the third UE (200c) exchange capability information to determine the appropriate method for the IDC session transfer. The first UE (200a) sends the ‘SIP OPTIONS’ request to the third UE (200c) to determine if the IDC session transfer is supported. The third UE (200c) responds with ‘200 OK’, containing the feature tag indicating the supported IDC transfer method. For example, feature Tags may include c-transfer-httpft, dc-transfer-dcft, etc.

At operations 504 and 505, before initiating the session transfer, the first UE (200a) shares its application state data, embedded in the multipart data structure and transmitted as XML content within the ‘INVITE’ message. The pre-transfer exchange ensures that the third UE (200c) may seamlessly continue the call with the necessary session information.

At operations 506, upon receiving the application state data, the third UE (200c) downloads and stores it in its local database. This data may be used once the first UE (200a) completes the transfer process.

At operations 507 and 508, the first UE (200a) initiates the IDC session transfer by sending a ‘REFER SIP request’ to the IMS. The call-info headers in the request may include a File-correlation-ID to identify the correct application State. The application state is based on web application that may be stored based on a DOMString in the XML. Further, the call-info header may include URL to access the application state data and timestamp of the data transfer.

At operations 509 and 510, the IMS network (201) processes the REFER request and sends an ‘INVITE’ message to the third UE (200c). The ‘INVITE’ message may include the call-info header received from the first UE (200a). The ‘INVITE’ message helps third the UE (200c) retrieve the application state data and take over the IDC session.

At operations 511, 512, and 513, the third UE (200c) retrieves the application state from its local database using the file-correlation ID. The IDC session resumes between the second UE (200b) and the third UE (200c), ensuring the seamless transition with the transferred session state.

The disclosure discloses multiple methods for transferring the IDC session, ensuring compatibility with industry standards. Capability exchange between the first UE (200a) and the third UE (200c) is necessary to negotiate a transfer method. The feature tags act as identifiers for the negotiated transfer method (e.g., dc-transfer-httpft for FT-Based Transfer).

Further, the call-info header contains the URL, File-correlationID, and Timestamp, enabling the transfer-target (third UE (200c)) to retrieve and continue the application state. the application state, stored as the DOMString in XML format, ensures faster and secure transfer while maintaining confidentiality between the transferor (first UE (200a)) and transfer-target (third UE (200c)), preserving session continuity. The FIG. 5 enables IDC session transfer while preserving session integrity. The use of feature tags, application state transfer, and call-info headers ensures the smooth transition.

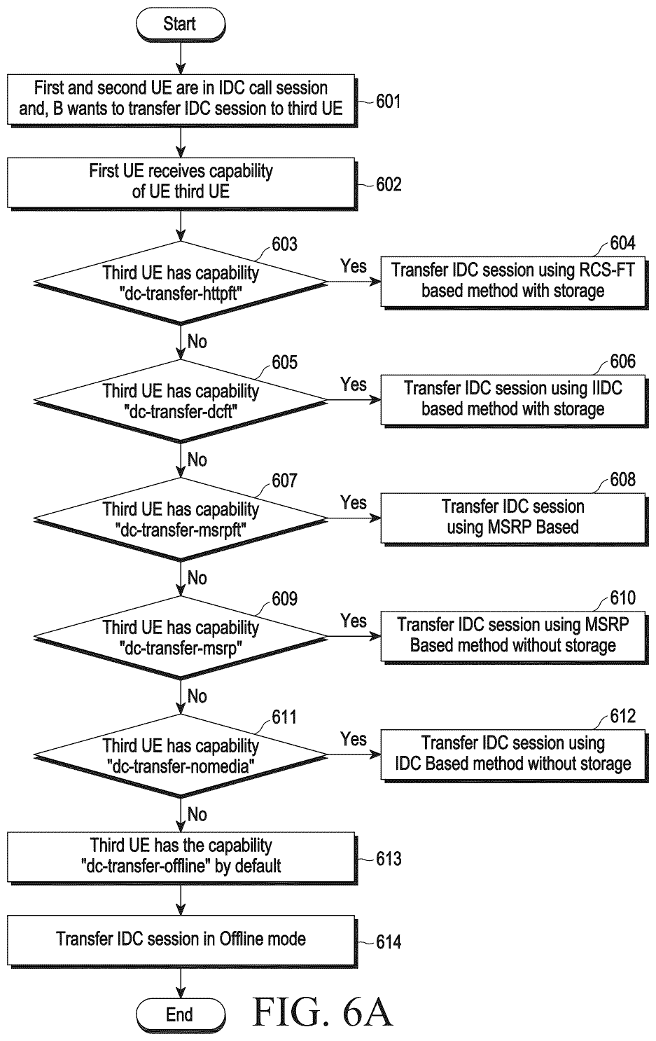

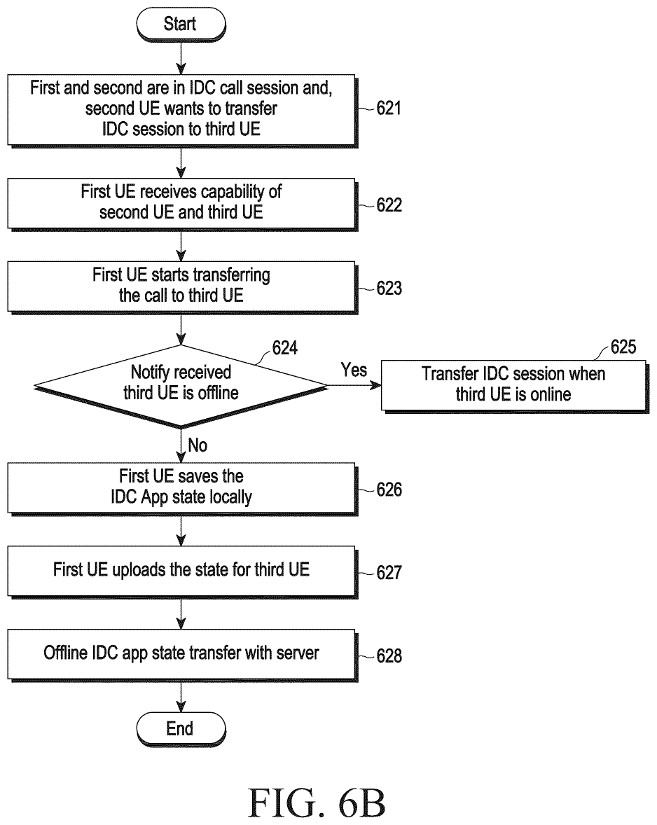

FIG. 6A is a flowchart that illustrates a method for enabling an IDC session continuity during a call transfer in an IMS network, specifically in a scenario where a third UE is available (online) to receive a call according to an embodiment of the disclosure.

Referring to FIG. 6A, at operation 601, initiating the process when the second UE (200b) and the first UE (200a) are in the ongoing IDC call, and the second UE (200b) determining to transfer the call to the third UE (200c).

At operation 602, sending the SUBSCRIBE or OPTIONS request message to the third UE (200c) from the first UE (200a) to retrieve its capabilities. Further, receiving the SUBSCRIBE or OPTIONS response message at the first UE (200a) from the third UE (200c) containing feature tags indicating supported transfer capabilities.

Additionally analyzing the response to determine third UE's (200c) capabilities based on the feature tags. Further, determining whether the third UE (200c) is online or offline. If offline, proceeding with operation 606 (as disclosed in FIG. 6A). If online, proceeding with operation 603.

At operation 603, determining whether the third UE (200c) supports the ‘dc-transfer-httpft’ feature tag. If yes, control proceeding with operation 604 otherwise proceeding with operation 605.

At operation 604, transferring the IDC session application state data from the first UE (200a) to the third UE (200c) using the RCS-FT based method with storage involving the storage server.

At operation 605, determining whether the third UE (200c) support the ‘dc-transfer-dcft’ feature tag. If yes, proceeding with operation 706 otherwise proceeding with operation 707.

At operation 606, transferring the IDC session application state data from the first UE (200a) to the third UE (200c) using the IDC based method with storage involving the storage server.

At operation 607, determining whether the third UE (200c) support the ‘dc-transfer-msrpft’ feature tag. If yes, proceeding with operation 608, otherwise proceed with operation 609.

At operation 608, transferring the IDC session application state data from the first UE (200a) to the third UE (200c) using the MSRP based method with storage involving the storage server.

At operation 609, determining whether the third UE (200c) support the ‘dc-transfer-msrp’ feature tag. If yes, proceeding with operation 610 otherwise proceeding with operation 611.

At operation 610, transferring the IDC session application state data from the first UE (200a) to the third UE (200c) using the MSRP based method without storage.

At operation 611, determining whether the third UE (200c) support the ‘dc-transfer-nomedia’ feature tag. If yes, proceeding with operation 612 otherwise proceeding with operation 613.

At operation 612, transferring the IDC session application state data from the first UE (200a) to the third UE (200c) using the IDC based method without storage. Proceeding with operations 613 and 614, where the third UE (200c) has the ‘dc-transfer-offline’ capability by default. If third UE (200c) is offline and unavailable at the time of the call, proceeding with FIG. 6B. FIG. 6A disclosed the second UE (200b) transferring the IDC application context to the third UE (200c).

FIG. 6B is a flowchart that illustrates a method for enabling an IDC session continuity during a call transfer in an IMS network, specifically in a scenario where a third UE is unavailable (offline) to receive the call according to an embodiment of the disclosure.

Referring to FIG. 6B, at operation 621, establishing the ongoing IDC call between the second UE (200b) and the first UE (200a). Further, initiating the call transfer procedure by the first UE (200a).

At operation 622, retrieving capabilities of both second UE (200b) and the third UE (200c) by transmitting SUBSCRIBE/OPTIONS messages by the first UE (200a).

At operation 623, transferring the call from the second UE (200b) to the third UE (200c) using the call transfer flows. The REFER method is used to instruct second UE (200b) to initiate the call towards the third UE (200c).

At operation 624, determining whether the third UE (200c) is available (online) to receive the call. If a NOTIFY message is received indicating successful call connection, the process follows the for online transfer scenarios (625) which is further disclosed in the FIG. 6A.

At operation 626, storing the IDC application state in association with third UE's (200c) address or if third UE (200c) is unavailable. The first UE (200a) performs the local storage operation to maintain the IDC session continuity. In other words, the first UE (200a) transfers the IDC session application state data to the third UE (200c) in the offline mode using the dc-transfer-offline capability

At operation 627, transferring the stored file to the second UE (200b) or the IMS Network (201) from first UE (200a).

At operation 628, following the SMS-Based method where the file transfer mechanism utilizes SMS due to the third UE's (200c) offline status.

Further, the second UE (200b) or IMS network (201) will then transfer the <ims.dc> file to third UE (200c) when third UE (200c) becomes available, following the file transfer procedures according to the capabilities of the third UE (200c) that are previously determined.

This method advantageously enables the IDC session state to be preserved and then restored when the target device becomes available, thereby maintaining continuity of the IDC session despite temporary unavailability of the target device during the call transfer process.

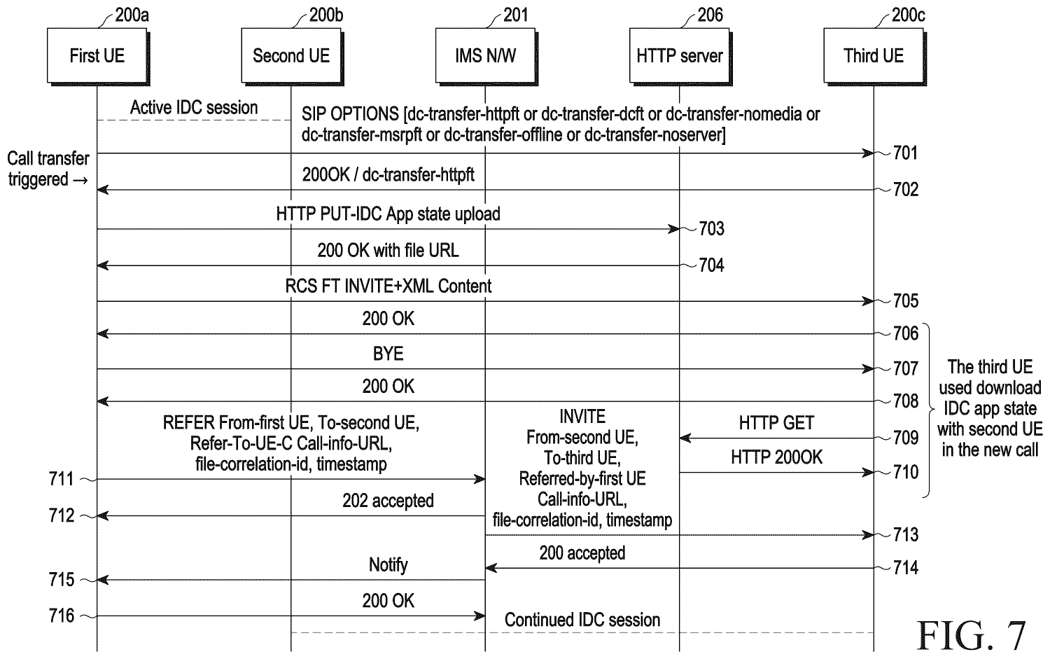

FIG. 7 is the sequence diagram that illustrates an IDC Application State Transfer using HTTP Server with an RCS FT method according to an embodiment of the disclosure.

Referring to FIG. 7, the second UE (200B) and the first UE (200a) are in Call and the first UE (200a) wants to transfer the ongoing IDC call to the UE C. Further, the first UE (200a) and the third UE (200c) are the RCS enabled clients and supports file transfer using the HTTP. Further, to avoid lag in call establishment, the IDC application state data needs to be transferred to the third UE (200c) before the call is established.

At operations 701 and 702, the first UE (200a) checks the capabilities of the third UE (200c) using the SUBSCRIBE/OPTIONS mechanism. The capability feature tag for this method is “dc-transfer-httpft”. If the third UE (200c) supports HTTP-based file transfer, the process continues with RCS FT-HTTP.

At operations 703 and 704, the first UE (200a) uploads the IDC session state data to the operator's HTTP storage server. This ensures that the third UE (200c) may retrieve the necessary session data before the call transfer.

At operations 705 to 708, the first UE (200a) sends the SIP INVITE (multipart) to the third UE (200c). The INVITE message contains the metadata XML, which includes Previous app state ID, file URL (where IDC session data is stored). file correlation ID, participant information (for session tracking).

At operations 709 and 710, upon receiving the SIP INVITE, the third UE (200c) extracts the file URL from the metadata XML and sends the ‘HTTP GET’ request to the HTTP server. The HTTP server responds with ‘HTTP 200K’, indicating that the file is available and successfully fetched. Further, the third UE (200c) then downloads the IDC session state file and saves the application state to its local database, using the previous application state ID as the primary key.

At operations 711 and 712, the first UE (200a) sends the SIP REFER message (as per RFC 5589) to the IMS network (201). The REFER message contains the call-info header, which includes details about the ongoing session.

At operations 713 and 714, the IMS Network (201) receives the REFER request and initiates the call to the third UE (200c). The Call-Info header remains unchanged during the process.

At operations 715 and 716, the third UE (200c) retrieves the application state from its local database and resumes the IDC session from the exact point where first UE (200a) left off. This ensures the seamless transition without losing session context. Further, if the transfer is successful, the first UE (200a) sends the BYE message to terminate its call with the second UE (200b) and the 200K (SIP 200 OK) response is sent to acknowledge the termination. FIG. 7 discloses the IDC call is transferred without lag, and the third UE (200c) may seamlessly continue the session from the previous state.

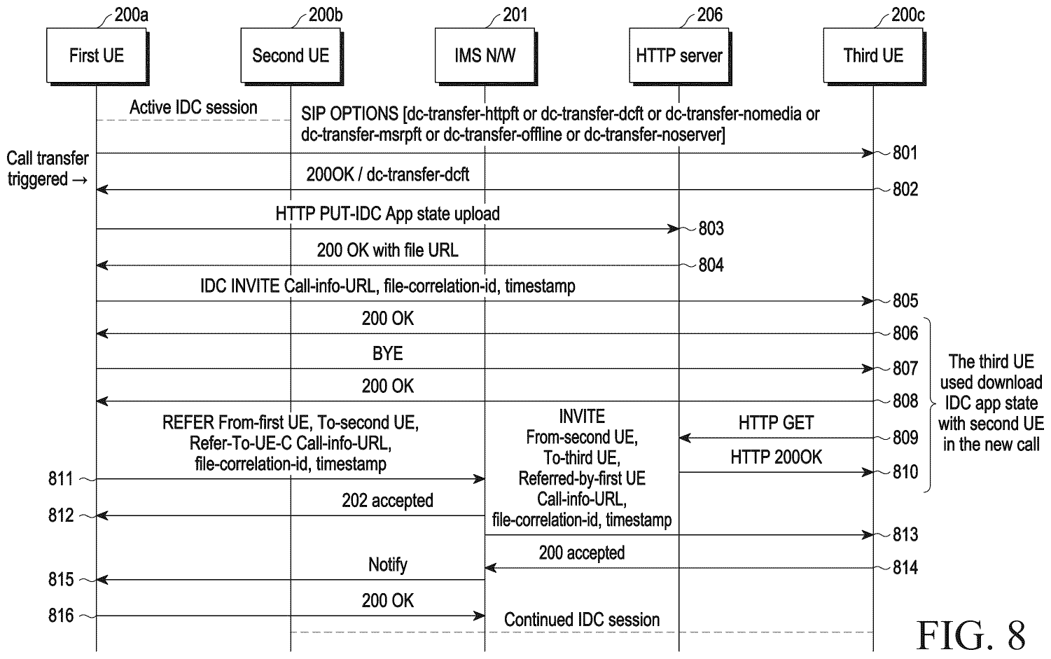

FIG. 8 is a sequence diagram that illustrates an IDC application state transfer using an IDC method according to an embodiment of the disclosure.

Referring to FIG. 8, the first UE (200a) uploads the IDC session application state data to the operator's HTTP storage server before initiating the transfer of the IDC call. It is assumed that neither the first UE (200a) nor the third UE (200c) are the RCS enabled clients.

At operations 801 and 802, the first UE (200a) checks whether the third UE (200c) supports the IDC transfer method using the feature tag “dc-transfer-dcft”.

At operations 803 and 804, the first UE (200a) uploads the IDC session application state data to the operator's HTTP storage server before transferring the call and the first UE (200a) initiates the IDC session with the third UE (200c) before transferring the call.

At operations 805 and 808, the first UE (200a) sends the SIP INVITE message to UE C, including call-Info header, which contains previous app state ID, file URL (location of the uploaded state data), file correlation ID, participant information, ‘+sip.app-subtype media’ feature tag.

At operations 809 and 810, upon receiving the SIP INVITE, the third UE (200c) extracts the file URL from the metadata XML and sends the ‘HTTP GET’ request to the HTTP server. The HTTP server responds with HTTP 200K, indicating that the file is available and successfully fetched. Further, the third UE (200c) then downloads the IDC session state file and saves the application state to its local database, using the previous application state ID as the primary key.

At operations 811 and 812, the first UE (200a) sends the SIP REFER message (as per RFC 5589) to the IMS Network (201). The REFER message contains the Call-Info header, which includes details about the ongoing session.

At operations 813 and 814, the IMS Network (201) receives the REFER request and initiates the call to the third UE (200c). The Call-Info header remains unchanged during the process.

At operations 815 and 816, the third UE (200c) retrieves the application state from its local database and resumes the IDC session from the exact point where the first UE (200a) left off. This ensures the seamless transition without losing session context. Further, if the transfer is successful, the first UE (200a) sends the BYE message to terminate its call with the second UE (200b) and the 200K (SIP 200 OK) response is sent to acknowledge the termination. FIG. 8 ensures that the IDC session resumes without lag, making the call transfer seamless.

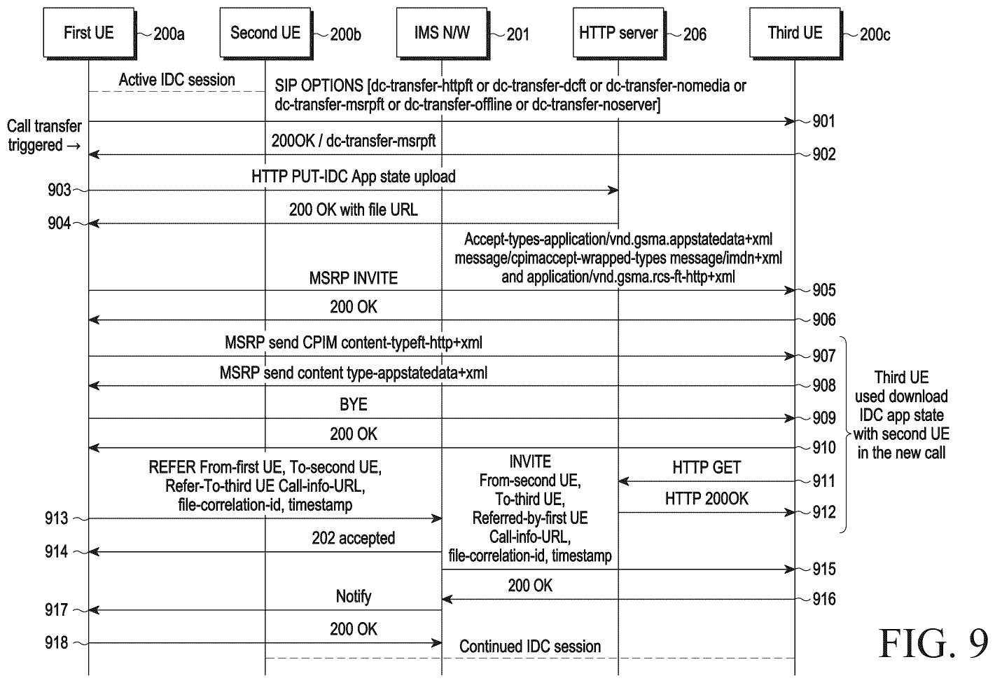

FIG. 9 is the sequence diagram that illustrates the IDC Application State Transfer using the MSRP method, according to an embodiment of the disclosure.

Referring to FIG. 9, since both first UE (200a) and third UE (200c) support the MSRP for data transfer, the IDC session application state is transferred using the HTTP storage and the MSRP communication before establishing the call with the third UE (200c). This ensures the seamless transition without any delay in call setup.

At operations 901 and 902, the first UE (200a) checks whether the third UE (200c) supports the MSRP transfer method using the feature tag “dc-transfer-msrpft”.

At operations 903 and 904, the first UE (200a) uploads the IDC session application state data to the operator's HTTP storage server before transferring the call and the first UE (200a) initiates the IDC session with the third UE (200c) before transferring the call. The server responds with the 200 OK message, providing the file URL where the data is stored.

At operation 905 and 906, the first UE (200a) initiates the MSRP session with the third UE (200c) for real-time metadata exchange. Further, the first UE (200a) sends the SIP INVITE message to the third UE (200c), including call-Info header, which contains previous app state ID, file URL (location of the uploaded state data), file correlation ID, participant information.

At operations 907 and 908, upon receiving the SIP INVITE, the third UE (200c) establishes the MSRP session with the first UE (200a). The third UE (200c) receives meta-data XML content over the MSRP and stores the application state in the local database, using the previous application state ID as the primary key.

At operations 909 and 910, upon receiving the SIP INVITE, the third UE (200c) extracts the file URL from the metadata XML and sends the ‘HTTP GET’ request to the HTTP server. The HTTP server responds with HTTP 200K, indicating that the file is available and successfully fetched. Further, the third UE (200c) then downloads the IDC session state file and saves the application state to its local database, using the previous application state ID as the primary key.

At operations 911 and 912, the first UE (200a) sends the SIP REFER message (as per RFC 5589) to the IMS Network (201). The REFER message contains the Call-Info header, which includes details about the ongoing session.

At operations 913 and 914, the IMS Network (201) receives the REFER request and initiates the call to the third UE (200c). The call-Info header remains unchanged during the process.

At operations 915 and 916, the third UE (200c) retrieves the application state from its local database. The third UE (200c) resumes the IDC session exactly from the state where the first UE (200a) left off, ensuring the smooth transition. FIG. 9 ensures the seamless IDC session continuity between the RCS-enabled clients without delay.

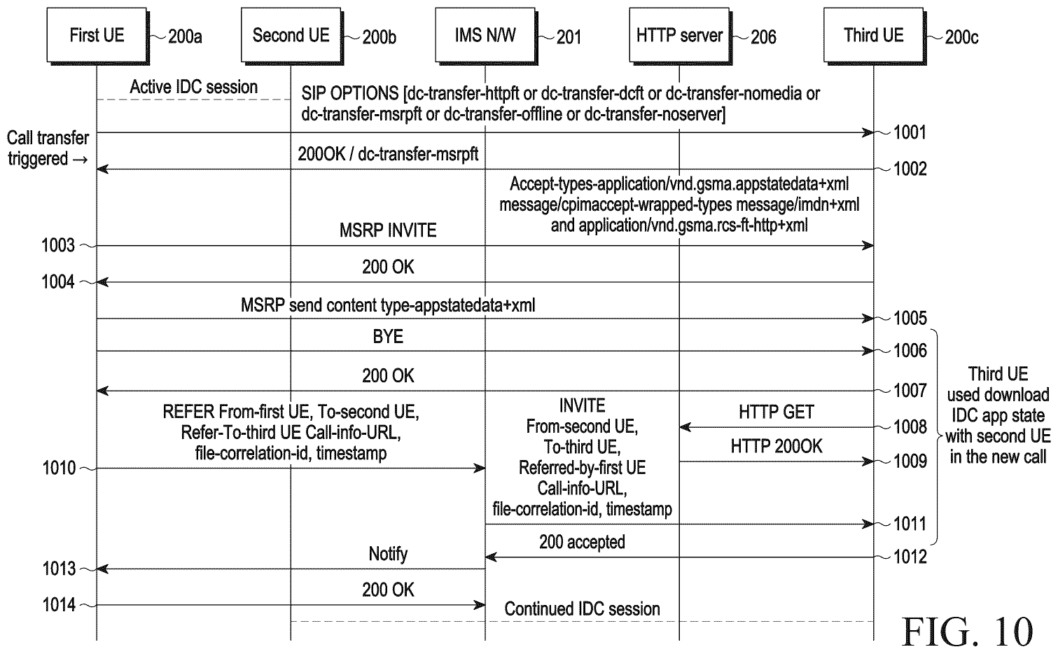

FIG. 10 is the sequence diagram that illustrates the IDC App state transfer using the MSRP Method without the server. In this scenario, the second UE (200B) and the first UE (200a) are engaged in the ongoing IDC call, and the first UE (200a) intends to transfer the call to the third UE (200c). Both the first UE (200a) and the third UE (200c) are RCS enabled clients that support the MSRP for data transfer.

To ensure the seamless call transfer and avoid any delay in call establishment with the third UE (200c), the IDC session application state data is transferred before initiating the call with the UEs.

At operations 1001 and 1002, the first UE (200a) checks whether the third UE (200c) supports the MSRP transfer method using the feature tag “dc-transfer-msrp”. The IDC session application state data is transferred directly between the first UE (200a) and third UE (200c) using the MSRP without involving the storage server.

At operations 1003 and 1007, the first UE (200a) establishes the MSRP session with the third UE (200c) for the application state transfer. The call-Info header is added to the SIP INVITE request, which carries metadata such as the previous application state ID, the file URL, the file correlation ID, and participant information.

At operations 1008 and 1009, upon receiving the SIP INVITE request, the third UE (200c) establishes the MSRP session with the first UE (200a) to receive the IDC session application state data. The received application state is stored locally using the previous application state ID as the primary key.

At operation 1010, the first UE (200a) sends the SIP REFER message (as per RFC 5589) to the IMS network (201). The REFER message contains the call-info header, which includes details about the ongoing session.

At operations 1011 and 1012, the IMS network (201) receives the REFER request and initiates the call to the third UE (200c). The Call-Info header remains unchanged during the process.

At operations 1013 and 1014, the third UE (200c) retrieves the application state from its local database. The third UE (200c) resumes the IDC session exactly from the state where first UE (200a) left off, ensuring the smooth transition. FIG. 10 ensures the smooth transition of the ongoing IDC call to the third UE (200c) without significant delays or loss of application state information.

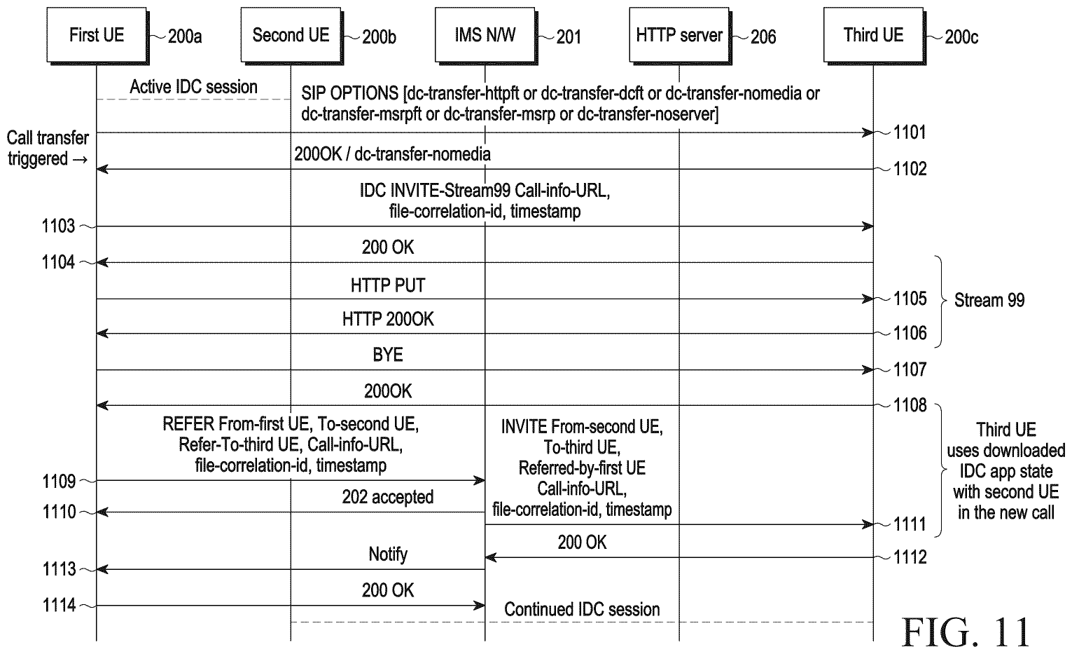

FIG. 11 is a sequence diagram that illustrates an IDC App State Transfer Using an IDC method without the server according to an embodiment of the disclosure.

Referring to FIG. 11, the second UE (200b) and the first UE (200a) are engaged in the ongoing IDC call, and the first UE (200a) intends to transfer the call to the third UE (200c). However, either the first UE (200a) or the third UE (200c) is not the RCS-enabled client, requiring an alternative approach for application state transfer.

At operations 1101 and 1102, the first UE (200a) checks whether the third UE (200c) supports the IDC transfer method using the feature tag “dc-transfer-nomedia”. The IMS data channel session application state is transferred directly between the first UE (200a) and the third UE (200c) without relying on the storage server.

At operation 1103 to 1108, the first UE (200a) establishes the IDC session with the third UE (200c) and allocates the dedicated stream (Stream 99) for sending and receiving application state data. The first UE (200a) sends the ‘HTTP PUT’ request over Stream 99, transferring the application state data, including metadata such as the file URL, file correlation ID, and timestamp. The third UE (200c) acknowledges successful receipt of the data with the ‘HTTP 200 OK’ response, confirming that the application state has been stored locally.

At operation 1109 and 1110, the first UE (200a) may include the call-Info header in the SIP INVITE request, carrying key details such as the previous application state ID, file URL, file correlation ID, and participant information. Upon receiving the SIP INVITE request, the third UE (200c) listens on the Stream 99 and periodically polls for the application state data using ‘HTTP GET’.

At operation 1111 and 1112, the first UE (200a) may send the SIP REFER request (as per RFC 5589) to the IMS network (201), instructing the transfer of the call to the third UE (200c) while maintaining the Call-Info header.

At operation 1113 and 1114, the IMS network (201) may initiate the call to the third UE (200c) with the unchanged Call-Info header. The third UE (200c) may retrieve the application state from the local database and resumes the IDC session from the point where the first UE (200a) left off. FIG. 11 ensures efficient and reliable application state transfer without the need for an external server, facilitating the smooth handover of the IDC session.

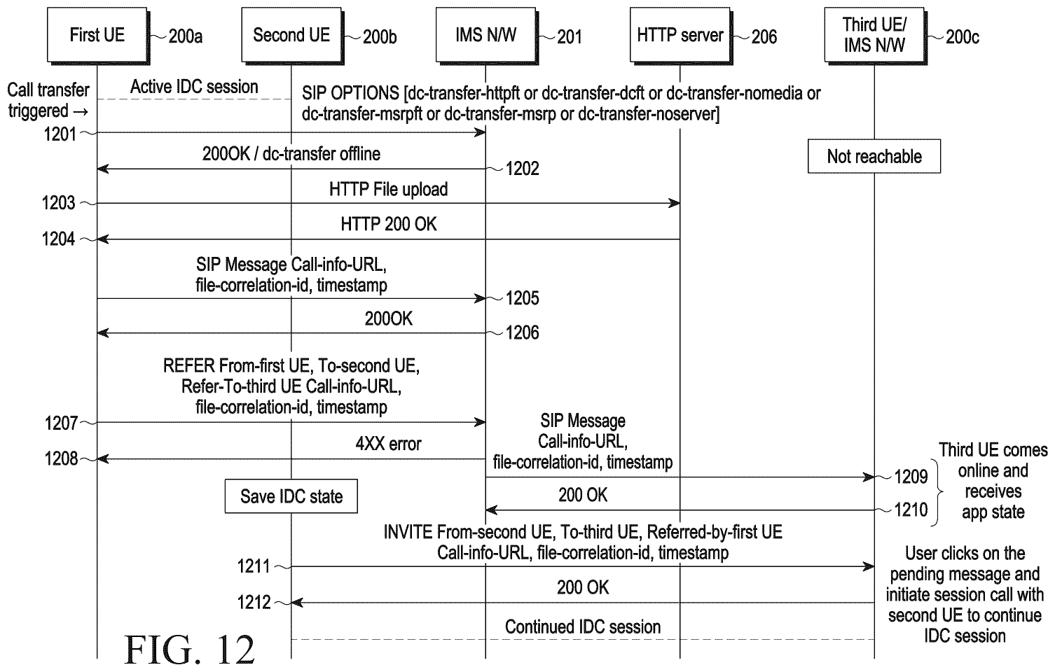

FIG. 12 is a sequence diagram that illustrates an IDC App State Transfer using an offline IDC method with a server (SMS method) according to an embodiment of the disclosure.

Referring to FIG. 12, where the second UE (200b) and the first UE (200a) are engaged in an ongoing IDC call, the first UE (200a) wants to transfer the call to the third UE (200c). However, the third UE (200c) is either not the RCS-capable device (unable to support RCS's) or unavailable to receive the IDC state or the call transfer.

At operations 1201 and 1202, the first UE (200a) checks whether the third UE (200c) supports the IDC transfer method using the feature tag “dc-transfer-offline”. If third UE (200c) does not support real-time IDC transfer, the offline transfer mechanism is triggered.

At operations 1203 and 1204, the first UE (200a) uploads the IDC session application state to the HTTP server since the third UE (200c) is unavailable.

At operations 1205 and 1206, Once the IDC state is stored on the HTTP server, first UE (200a) transmits the SIP Message via SMS, RCS Standalone, or RCS Chat to the third UE (200c). This message contains the file URL, file correlation ID, and timestamp, allowing the third UE (200c) to retrieve the state later. Further, to maintain continuity in the IDC session, the first UE (200a) may include the Call-Info header in the SIP INVITE request. The Call-Info header carries critical information, including Previous App State ID, file URL, file Correlation ID, participant Information. This confirms that when the third UE (200c) becomes available, it may correctly resume the IDC session using the stored state data.

At operations 1207 and 1208, the first UE (200a) attempts to transfer the IDC call by sending the SIP REFER request (as per RFC 5589) to the IMS network (201). However, since the third UE (200c) is unreachable or not RCS-enabled, the IMS server responds with the client error, indicating that the transfer cannot be completed. Since the third UE (200c) is unavailable, the second UE (200b) stores the received IDC state data locally in its database. This ensures that the session may be resumed once the third UE (200c) is online.

At operation 1209 and 1212, when the third UE (200c) becomes available or comes online, it retrieves the IDC session state from the stored URL by downloading it from the HTTP server. The third UE (200c) then stores the downloaded IDC state in its local database. Once the IDC state is retrieved, the third UE (200c) detects the special message containing the stored URL to initiate the call. When the user clicks on this message, the device automatically initiates the IDC session call to the second UE (200b), allowing the session to resume from the previously stored state. FIG. 12 provides the seamless session continuity even in scenarios where the call transfer cannot be completed in real-time due to the third UE (200c) limitations.

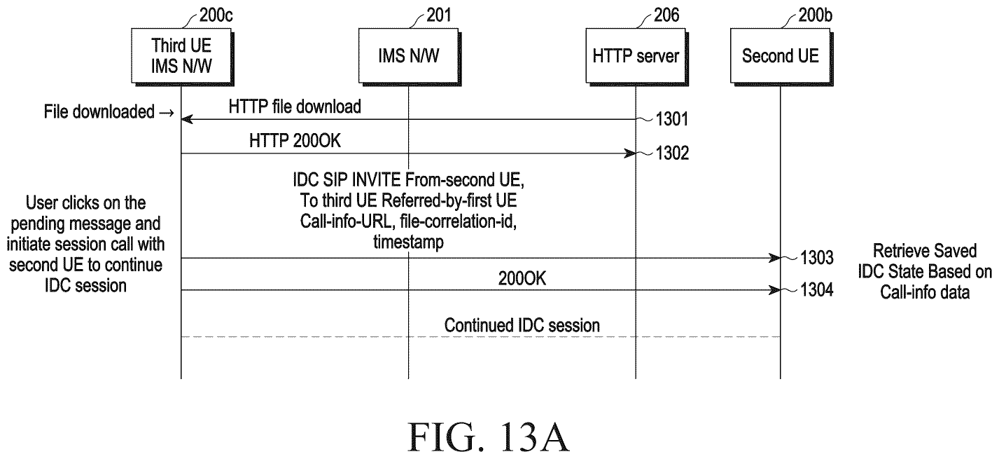

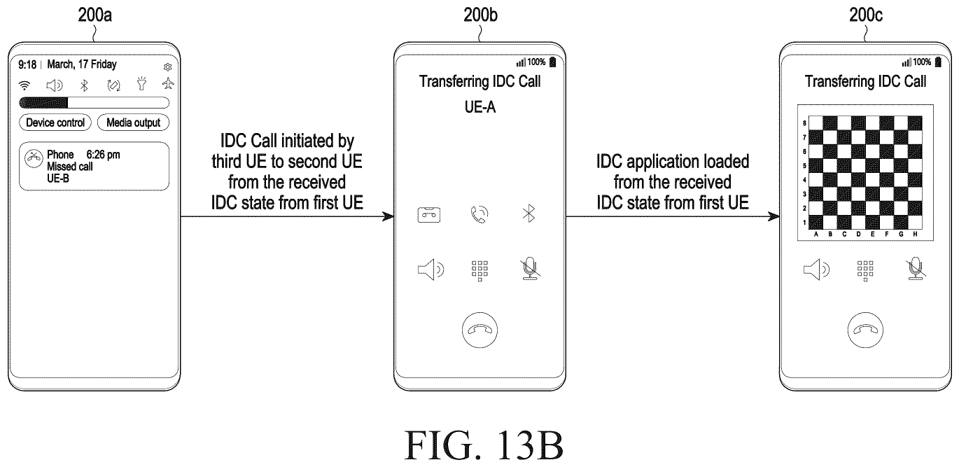

FIG. 13A is a sequence diagram that illustrates a flow of a third UE Calling a second UE from a received IDC State according to an embodiment of the disclosure.

Referring to FIG. 13A, at operations 1301 and 1302, the third UE (200c) receives the SMS or RCS message containing the IDC session details, including call-Info URL, file Correlation ID, timestamp. The user on the third UE (200c) clicks the message, which initiates the new IDC session call to the second UE (200b).

At operation 1303, the third UE (200c) sends the IDC SIP INVITE request to the second UE (200b), which includes the call-Info Header. The call info header involves URL, file correlation ID and time stamp. Further, the second UE (200b) retrieves the saved IDC state based on the Call-Info data included in the SIP INVITE. The IDC session details are restored from the HTTP server or local storage.

At operation 1304, once the second UE (200b) successfully retrieves the saved session state, it sends the ‘200 OK’ response back to the third UE (200c). This confirms the successful resumption of the IDC session. After receiving the ‘200 OK’ response, the third UE (200c) and the second UE (200b) continue the IDC session from the previously saved state. The session is re-established, ensuring seamless communication despite the delayed call transfer.

FIG. 13B is a schematic representation that illustrates a scenario where a third UE initiates an IDC call with a second UE based on a received IDC session state from a first UE according to an embodiment of the disclosure.

Referring to FIG. 13B, the third UE (200c) receives the notification indicating the missed call from the first UE (200a), which includes information about the transferred IDC session. Using this information, the third UE (200c) initiates the IDC call with the second UE (200b), as shown in FIG. 13A, where the call interface indicates the ongoing IDC session. Once the call is established, the IDC application retrieves and loads the saved IDC state from the first UE (200a), enabling seamless continuity of the session. The successful retrieval of the IDC session data, ensuring that the shared application or content (such as a game or document) is restored. The FIG. 13B highlights the effectiveness of the IDC state preservation in maintaining session continuity across different UEs.

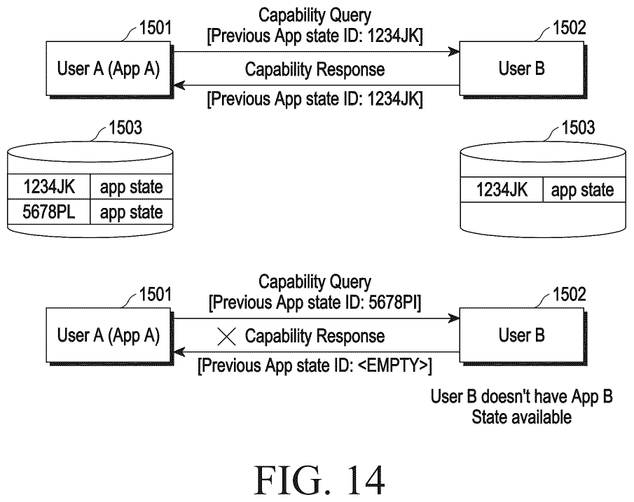

FIG. 14 is a block diagram that illustrates a process of capability exchange and an IDC application state ID generation according to an embodiment of the disclosure.

Referring to FIG. 14, the IDC application state is stored in loc the local database (1503) to ensure seamless continuity of the IDC session. To identify the application state for the specific call or user, an application state ID is generated based on the transferor phone number, the transferee phone number, and the application ID. The generated application state ID remains identical between the transferor or User A (1501) and transferee or user B (1502), enabling both entities to verify the availability of the application state during the capability check. Each entity performs the database lookup using the generated ID to determine whether the application state is available. The application state ID may be generated as a combination of the Transferor number, Transferee number, and application ID. The Transferor (1501) and Transferee (1502) numbers are arranged in increasing order, excluding the country code. This ensures the efficient approach for identifying and retrieving the application state across different devices. In scenarios, where a corresponding application state is unavailable at the transferee (1502) side, IDC session continuity may be impacted, (as illustrated in FIG. 14) where User B does not have the application state of App B available.

Further, the IDC application state to be transferred must adhere to the specified metadata XML format to ensure accurate identification and seamless continuity of the IDC session. The metadata format may include essential information such as the matching call ID, participant details, timestamps, and other relevant data necessary for associating the IDC session state with the specific call session and its respective participants.

Additional fields-
<previous-appstate-id> - Unique Id to identify the IDC state
<file-correlation-id> - callid can be used to understand
which session this app state
belongs to
<other-participant> - This field can tell who was other
participant when app state is
shared.
<Referred-by> - This Field carries the referrer's identity
<timestamp> time stamp when user uploads file
<?xml version=“1.0” encoding=“UTF-8”?>
<file xmlns=“urn:gsma:params:xml:ns:rcs:rcs:fthttp”
xmlns:x=“urn:gsma:params:xml:ns:rcs:rcs:up:fthttpext”>
<file-info type=“thumbnail”
<file-size>xxx</file-size>
<content-type>datachannel</content-type>
<data url=““ until=””/></file-info>
<file-info type=“file”>
<file-size>xxx</file-size>
<file-name>ABC.dc</file-name>
<content-type>datachannel</content-type>
<data url=““ until=””/>
<x:branded-url></x:branded-url>
<previous-appstate-id>1234</previous-appstate-id>
<file-correlation-id>xxx</file-correlation-id>
<other-participant>B</other-participant>
<Referred-by>A</Referred-by>
<timestamp>xxx</timestamp>
</file-info></file>

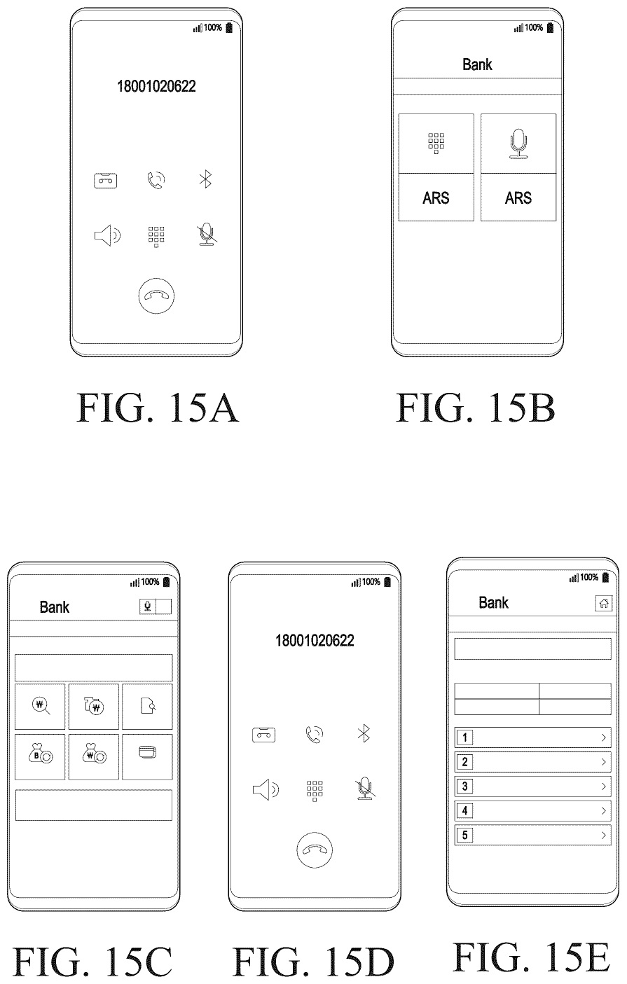

FIGS. 15A through 15E are schematic representations of the use case to transfer the data channel call session seamlessly according to various embodiments of the disclosure. The process involves business-to-customer (B2C) interactive calls between a customer care representative and a customer.

Referring to FIGS. 15A to 15E, the customer initiates the call to the customer service center, engaging in the interactive voice session.

FIGS. 15A and 15B represents the customer call. The customer selects a relevant service option, such as checking transaction details or transferring funds or other issues, while staying connected to the call.

FIGS. 15C and 15D discloses that if any specific information, such as files or documents or other query, is required but is not immediately available, the call session can be transferred to another user who has access to the required data. This ensures that the necessary documents or files are retrieved and shared seamlessly within the same session.

FIG. 15E represents that once the required information is accessed and shared, the session is either concluded or redirected to the first customer care agent for further assistance.

FIGS. 15A through 15E, ensures the smooth and uninterrupted transfer of the DC call session, allowing efficient retrieval and exchange of data without disconnecting the ongoing communication.

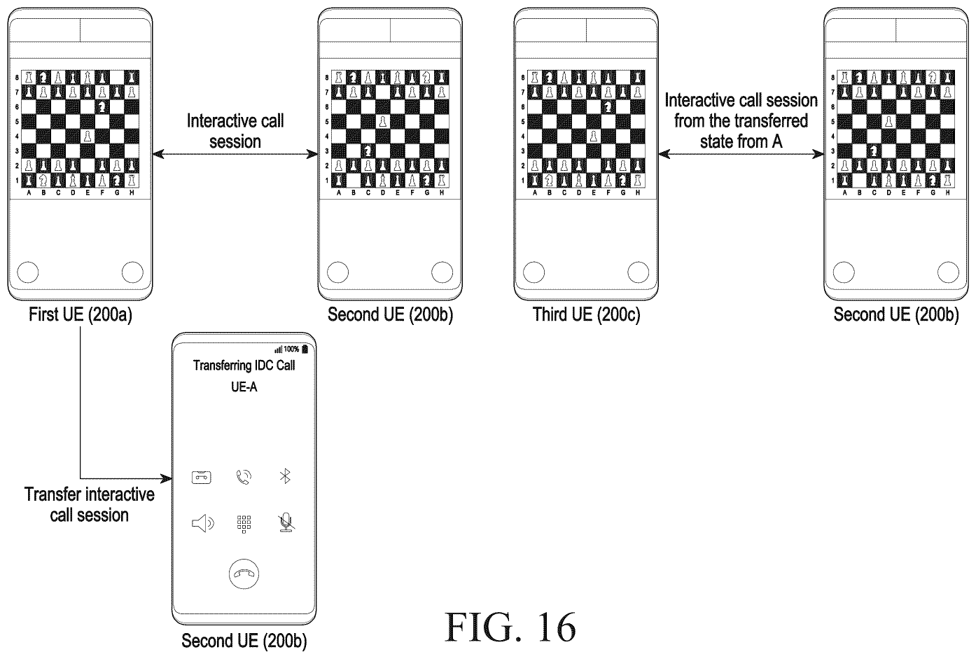

FIG. 16 is the block diagram that illustrates the example of the use case for seamless transfer of the data channel call session between users according to an embodiment of the disclosure.

For application state sharing, the user (second UE (200b)) may share the state of the application, such as a game, with another user (first UE (200a)) in real time. When the second UE (200b) initiates the transfer, the application state is synchronized with the UE-B, allowing them to resume the application from the same state. This ensures continuity and provides the uninterrupted user experience.

A collaborative editing facilitates real-time collaboration by allowing the second UE (200b) to transfer the ongoing document editing session to third UE (200c). Upon transfer, the recipient gains access to the document in its current state and may continue editing seamlessly. This feature enhances multi-user collaboration and efficiency by ensuring the stateful transfer of document modifications without data loss or redundancy.

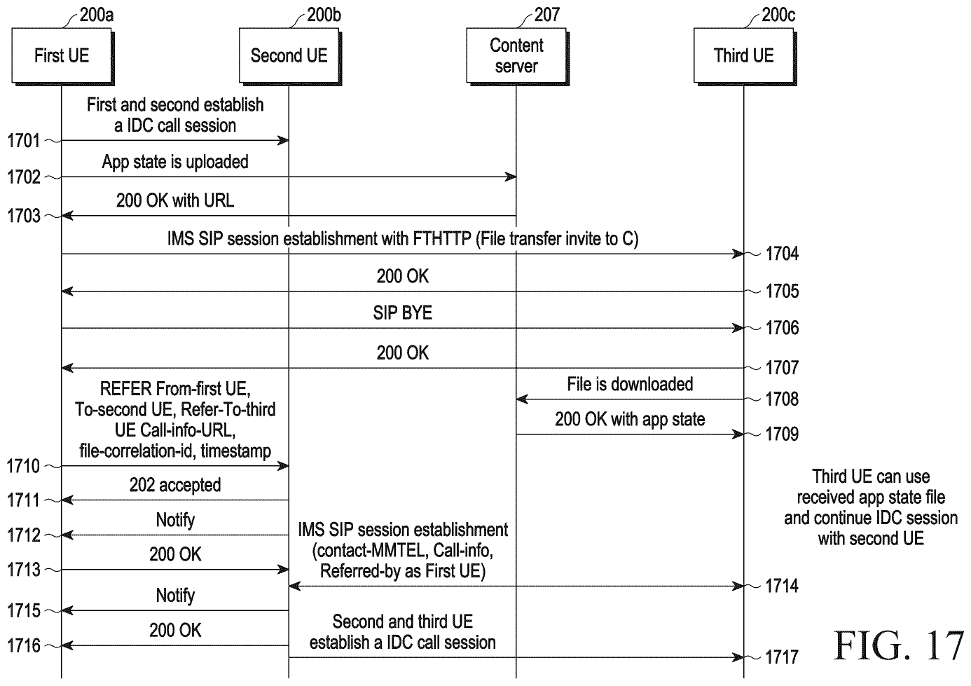

FIG. 17 is a sequence diagram that illustrates a scenario where a data channel application state is transferred using RCS file transfer when a third UE is RCS-capable according to an embodiment of the disclosure.

Referring to FIG. 17, at operation 1701, the first UE (200a) and the second UE (200b) establish the IDC call session.

At operations 1702 and 1703, the second UE (200b) uploads its app state to the content server. The content server responds with “200 OK with URL” to the first UE (200a), indicating successful upload and providing the URL to access the uploaded data.

At operations 1704 to 1707, the IMS SIP session is established between the content server (207) and the third UE (200c) using the file transfer HTTP protocol. The content server (207) sends the “Invite to third UE” message, initiating the file transfer. The third UE (200c) responds with “200 OK” acknowledging the session establishment. The content server (207) sends “SIP BYE” to terminate the SIP session after file transfer setup. The third UE (200c) acknowledges with “200 OK”.

At operation 1708 and 1709, the third UE (200c) downloads the file from the content server (207). The content server (207) confirms with “200 OK with app state”. The third UE (200c) may use the received app state file to continue the IDC session with the second UE (200b).

At operation 1710 and 1713, the first UE (200a) sends the REFER message to the second UE (200b) containing necessary parameters (From-first UE (200a), To-second UE (200b), Refer-To-third UE (200c) Call-Info-URL, file-correlation-id, timestamp).

At operation 1714 to 1717, the new IMS SIP session is established between the second UE (200b) and the third UE (200c) with parameters (contact-MMTEL, Call-info, Referred-by as B) and establishes the IDC call session directly. This approach enables seamless transfer of application state data between user the second UE (200b) using RCS file transfer capabilities, allowing third UE (200c) to join the existing communication session with the full context of the ongoing interaction.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first user equipment (UE) for transferring an internet protocol (IP) multimedia subsystem (IMS) data channel (IDC) session between UEs in a communication network system, comprising:
determining, by the first UE, that an IDC session has been established between the first UE and a second UE, wherein the first UE and the second UE is in an ongoing IDC call;
detecting, by the first UE, that an IDC call is being initiated by a third UE;
initiating, by the first UE, a transfer of IDC session application state data from the first UE to the third UE, while maintaining the ongoing IDC call between the first UE and the second UE; and
transmitting, by the first UE, the IDC session application state data to the second UE such that the second UE continues from same IDC session state where the first UE left-off with the third UE based on the IDC session application state data after the transfer is completed.

2. The method of claim 1,
wherein the initiating, by the first UE, the transfer of the IDC session application state data from the first UE to the third UE comprises transmitting, by the first UE, the IDC session application state data to the second UE, and
wherein the IDC session application state data is stored in the second UE such that the second UE and the third UE continues communication from the same IDC session state of the first UE based on the IDC session application state data.

3. The method of claim 1, wherein the initiating, by the first UE, the transfer of the IDC session application state data from the first UE to the third UE comprises:
transmitting, by the first UE, a request message to the third UE to retrieve a capability of the third UE;
receiving, by the first UE, a response message from the third UE;
determining, by the first UE, the capability of the third UE based on a feature tag available in the response message received from the third UE, wherein the feature tag indicates one of a data transfer using hyper text transfer protocol (HTTP) file transfer (dc-transfer-httpft), a direct connection file transfer (dc-transfer-dcft), a message session relay protocol file transfer (dc-transfer-msrpft), a dc-transfer-msrp, a dc-transfer-nomedia, wherein the third UE is online and the third UE has dc-transfer-offline when the third UE is offline;
transferring, by the first UE, the IDC session application state data from the first UE to the third UE using a rich communication services file transfer (RCS-FT) based method with a storage, when the capability indicates that the third UE has support for the dc-transfer-httpft;
transferring, by the first UE, the IDC session application state data from the first UE to the third UE using IDC based method with the storage, when the capability indicates that the third UE has support for the dc-transfer-dcft;
transferring, by the first UE, the IDC session application state data from the first UE to the third UE using message session relay protocol (MSRP) based method with the storage, when the capability indicates that the third UE has support for the dc-transfer-msrpft;
transferring, by the first UE, the IDC session application state data from the first UE to the third UE using MSRP based method without the storage, when the capability indicates that the third UE has support for the dc-transfer-msrp;
transferring, by the first UE, the IDC session application state data from the first UE to the third UE using IDC based method without the storage, when the capability indicates that the third UE has support for the dc-transfer-nomedia; and
transferring, by the first UE, the IDC session application state data from the first UE to the third UE in offline mode, when the capability indicates that the third UE has support for the dc-transfer-offline.

4. The method of claim 3, wherein the transferring, by the first UE, the IDC session application state data from the first UE to the third UE using the RCS-FT based method with the storage comprises:
uploading, by the first UE, an IDC session application state data to an operator HTTP storage server before initiating the transfer of the IDC session application state data;
establishing, by the first UE, a file transfer over HTTP (FToverHTTP) session with the third UE, wherein the third UE is the RCS enabled client supporting file transfer using HTTP;
adding, by the first UE, metadata and +sipapp-subtype media feature tag in a session initiation protocol (SIP) INVITE multipart message, wherein the metadata comprises at least one of a previous application state identifier (ID), a file uniform resource locator (URL), a file correlation ID, or participant information;
transmitting, by the first UE, the SIP INVITE multipart message to the third UE (200c); and
transmitting, by the first UE, a SIP REFER message to an IMS network server to initiate the transfer of the IDC session application state data, wherein the SIP REFER message includes a Call-Info header.

5. The method of claim 4, further comprising:
receiving, by the third UE, the SIP INVITE multipart message from the operator HTTP storage server, wherein the SIP INVITE multipart message includes the +sipapp-subtype media feature tag;
downloading, by the third UE, a file comprising the IDC session application state data from the operator HTTP storage server based on the SIP INVITE request;
storing, by the third UE, the IDC session application state data to a local database using the previous application state ID as a primary key;
receiving, by the third UE, a call from the IMS network server with the Call-Info header unchanged;
fetching, by the third UE, the IDC session application state data from the local database; and
resuming, by the third UE, the IDC session from the same IDC session state where the first UE left-off.

6. The method of claim 3, wherein the transferring, by the first UE, the IDC session application state data from the first UE to the third UE using the IDC based method with the storage comprises:
uploading, by the first UE, an IDC session application state data to an operator HTTP storage server before initiating the transfer of the IDS session application state data, wherein either the first UE or the third UE are not rich communication services (RCS) enabled clients;
establishing, by the first UE, an IDC session with the third UE;
adding, by the first UE, a Call-Info header and +sip.app-subtype media feature tag to a SIP INVITE multipart message, wherein the Call-Info header comprises a previous application state ID, a file uniform resource locator (URL), a file correlation ID, and participant information;
transmitting, by the first UE, the SIP INVITE multipart message to the third UE; and
transmitting, by the first UE, a SIP REFER request message to an IMS network server to transfer the IDC session application state data, wherein the SIP REFER request message includes the Call-Info header.

7. The method of claim 6, further comprising:
receiving, by the third UE, the SIP INVITE multipart message from the first UE, wherein the SIP INVITE multipart message comprises the Call-Info header and the +sip.app-subtype media feature tag;
downloading, by the third UE, the file from the operator HTTP storage server upon receiving the SIP INVITE request;
storing, by the third UE, the IDS application state data to a local database using the previous application state id as a primary key;
receiving, by the third UE, a call from the IMS network server with the Call-Info header unchanged;
fetching, by the third UE, the IDC session application state data from the local database; and
resuming, by the third UE, the IDC session from the same IDC session state where the first UE left-off.

8. The method of claim 3, wherein the transferring, by the first UE, the IDC session application state data from the first UE to the third UE using the MSRP based method with the storage comprises:
uploading, by the first UE, the IDC session application state data to an operator HTTP storage server before initiating the transfer of the IDC session application state data, wherein both the first UE and the second UE are RCS enabled clients supporting MSRP for data transfer;
establishing, by the first UE, an MSRP session with the third UE;
transmitting, by the first UE, a SIP INVITE multipart message by adding a +sip.app-subtype media feature tag to the third UE, wherein the SIP INVITE multipart message comprising metadata having at least one of previous application state ID, a file URL, a file correlation ID, or participant information; and
transmitting, by the first UE, a SIP REFER message to an IMS network server to transfer the IDC session application state data, wherein the SIP REFER message comprises a Call-Info header.

9. The method of claim 8, further comprising:
receiving, by the third UE, the SIP INVITE multipart message from the first UE, wherein the SIP INVITE multipart message comprises the Call-Info header and the +sip.app-subtype media feature tag;
establishing, by the third UE, a MSRP session with the first UE based on the SIP INVITE request;
receiving, by the third UE, the metadata over the MSRP session;
storing, by the third UE, the IDC session application state data to a local database using the previous application state ID as a primary key;
receiving, by the third UE, a call from the IMS network server with the Call-Info header unchanged;
fetching, by the third UE, the IDC session application state data from the local database; and
resuming, by the third UE, the IDC session from the same IDC session state where the first UE left-off.

10. The method of claim 3, wherein the transferring, by the first UE, the IDC session application state data from the first UE to the third UE using the MSRP based method without the storage comprises:
establishing, by the first UE, an MSRP session between the first UE and third UE, wherein the first UE and the second UE are RCS enabled clients that support MSRP for the transfer of the IDC session application state data;
adding, by the first UE, a Call-Info header and +sipapp-subtype media feature tag to a SIP INVITE request message, wherein the Call-Info header comprises at least one of previous application state ID, a file URL, a file correlation ID, or participant information;
transmitting, by the first UE, the SIP INVITE request message from the first UE to the third UE; and
transmitting, by the first UE, a SIP REFER request message to an IMS network server to transfer the IDC session application state data, wherein the SIP REFER request message includes the Call-Info header.

11. The method of claim 10, further comprising:
receiving, by the third UE the SIP INVITE request message from the first UE, wherein the SIP INVITE request message comprises the Call-Info header and the +sipapp-subtype media feature tag;
establishing, by the third UE, the MSRP session with the first UE based on the SIP INVITE request;
receiving, by the third UE, the Call-Info header over the MSRP session;
storing, by the third UE, the IDC session application state data to a local database using the previous application state ID as a primary key;
receiving, by the third UE, a call from the IMS network server with the Call-Info header unchanged;
fetching, by the third UE, the IDC session application state data from the local database; and
resuming, by the third UE, the IDC session from the same IDC session state where the first UE left-off.

12. The method of claim 3, wherein the transferring, by the first UE, the IDC session application state data from the first UE to the third UE using IDC based method without the storage comprises:
establishing, by the first UE, an IDC session with the third UE with a dedicated stream for transmitting and receiving the IDC session application state data, wherein at least one of the first UE or the second UE is not a RCS enabled client;
adding, by the first UE, a Call-Info header and +sipapp-subtype media feature tag to a SIP INVITE request, wherein the Call-Info header includes at least one of a previous application state ID, a file URL, a file correlation ID, or participant information;
transmitting, by the first UE, the SIP INVITE request message to the third UE; and
transmitting, by the first UE, a SIP REFER request message to an IMS network server to transfer the IDC session application state data, wherein the SIP REFER request message includes the Call-Info header.

13. The method of claim 12, further comprising:
receiving, by the third UE, the SIP INVITE request message from the first UE, wherein the SIP INVITE request message comprises the Call-Info header and the +sipapp-subtype media feature tag;
periodically polling, by third UE, the dedicated stream for the IDC session application state data based on the SIP INVITE request message;
storing, by the third UE, the IDC session application state data to a local database using the previous application state ID as a primary key;
receiving, by the third UE, a call from the IMS network server with the Call-Info header unchanged;
fetching, by the third UE, the IDC session application state data from the local database; and
resuming, by the third UE, the IDC session from the same IDC session state where the first UE left-off.

14. The method of claim 3, wherein the transferring, by the first UE, the IDC session application state data from the first UE to the third UE in the offline mode comprises:
uploading, by the first UE, the IDC session application state data to an HTTP server, wherein the third UE is not RCS capable and is unavailable to receive the IDC state or does not receive the transfer of the IDC session application state data;
transmitting, by the first UE, a SIP message to the second UE or an IMS network server, wherein the SIP message comprises file details related to the IDC session application state data;
adding, by the first UE, a Call-Info header and +sip.app-subtype media feature tag to a SIP INVITE request, the Call-Info header comprises at least one of a previous application state ID, a file URL, a file correlation ID, or participant information; and
transmitting, by the first UE, a SIP REFER request to the IMS network server to transfer the IDC session application state data, wherein the IMS network server responds with a client error indicating that the third UE is not reachable.

15. The method of claim 14, further comprising:
downloading, by the third UE the IDC session application state data from a local database when the third UE becomes available or comes online; and
initiating, by the third UE, the IDC call automatically by clicking on a message comprising a URL to complete pending IDC session.

16. A first user equipment (UE) for transferring an internet protocol (IP) multimedia subsystem (IMS) data channel (IDC) session between user equipments (UEs), comprising:
memory storing instructions; and
at least one processor,
wherein the instructions, when executed by the processor individually or collectively, cause the first UE to:
determine that an IDC session has been established between the first UE and a second UE, wherein the first UE and the second UE is in an ongoing IDC call,
detect that an IDC call is being initiated by a third UE,
initiate a transfer of IDC session application state data from the first UE to the third UE, while maintaining the ongoing IDC call between the first UE and the second UE, and
transmit the IDC session application state data to the second UE such that the second UE continues from same IDC session state where the first UE left-off with the third UE based on the IDC session application state data after the transfer is completed.

17. The first UE of claim 16,
wherein the instructions, when executed by the processor individually or collectively, further cause the first UE to transmit the IDC session application state data to the second UE, and
wherein the IDC session application state data is stored in the second UE such that the second UE and the third UE continues communication from the same IDC session state of the first UE based on the IDC session application state data.

18. The first UE of claim 16,
wherein the initiating, by the first UE, the transfer of the IDC session application state data from the first UE to the third UE, the instructions, when executed by the processor individually or collectively, further cause the first UE to transmit the IDC session application state data to the second UE, and
wherein the IDC session application state data is stored in the second UE such that the second UE and the third UE continues communication from the same IDC session state of the first UE based on the IDC session application state data.

19. The first UE of claim 16, wherein initiating, by the first UE, the transfer of the IDC session application state data from the first UE to the third UE, the instructions, when executed by the processor individually or collectively, further cause the first UE to:
transmit a request message to the third UE to retrieve a capability of the third UE;
receive a response message from the third UE;
determine the capability of the third UE based on a feature tag available in the response message received from the third UE, wherein the feature tag indicates one of a data transfer using hyper text transfer protocol (HTTP) file transfer (dc-transfer-httpft), a direct connection file transfer (dc-transfer-dcft), a message session relay protocol file transfer (dc-transfer-msrpft), a dc-transfer-msrp, a dc-transfer-nomedia, wherein the third UE is online and the third UE has dc-transfer-offline when the third UE is offline;
transfer the IDC session application state data from the first UE to the third UE using a rich communication services file transfer (RCS-FT) based method with a storage, when the capability indicates that the third UE has support for the dc-transfer-httpft;
transfer the IDC session application state data from the first UE to the third UE using IDC based method with the storage, when the capability indicates that the third UE has support for the dc-transfer-dcft;
transfer the IDC session application state data from the first UE to the third UE using message session relay protocol (MSRP) based method with the storage, when the capability indicates that the third UE has support for the dc-transfer-msrpft;
transfer the IDC session application state data from the first UE to the third UE using MSRP based method without the storage, when the capability indicates that the third UE has support for the dc-transfer-msrp;
transfer the IDC session application state data from the first UE to the third UE using IDC based method without the storage, when the capability indicates that the third UE has support for the dc-transfer-nomedia; and
transfer the IDC session application state data from the first UE to the third UE in offline mode, when the capability indicates that the third UE has support for the dc-transfer-offline.

20. One or more non-transitory computer-readable storage media storing one or more computer programs including computer-executable instructions that, when executed by one or more processors of a first user equipment (UE) individually or collectively, cause the first UE to perform operations, the operations comprising:
determining, by the first UE, that an data channel (IDC) session has been established between the first UE and a second UE, wherein the first UE and the second UE is in an ongoing IDC call;
detecting, by the first UE, that an IDC call is being initiated by a third UE;
initiating, by the first UE, a transfer of IDC session application state data from the first UE to the third UE, while maintaining the ongoing IDC call between the first UE and the second UE; and
transmitting, by the first UE, the IDC session application state data to the second UE such that the second UE continues from same IDC session state where the first UE left-off with the third UE based on the IDC session application state data after the transfer is completed.
